(19) United States
(12) Patent Application Publication
(10) Pub. No.: US 2026/0278309 A1
(43) Pub. Date: Sep. 17, 2026

(54) DISPLAY APPARATUS AND DATA PROCESSING METHOD

(71) Applicant: VIDAA (NETHERLANDS) INTERNATIONAL HOLDINGS B.V., Duiven (NL)

(72) Inventor: Juan DU, Qingdao (CN)

(21) Appl. No.: 19/157,189

(22) PCT Filed: May 15, 2024
(86) PCT No.: PCT/EP2024/063333

§ 371 Date: Aug. 15, 2025

(30) Foreign Application Priority Data
May 16, 2023 (CN) 202310553341.0
Mar. 29, 2024 (CN) 202410381050.2

(51) Int. Cl. G06F 40/58; G06F 40/263; G10L 15/26

(52) U.S. Cl. CPC G06F 40/58; G06F 40/263; G10L 15/26

(57) ABSTRACT

A display apparatus and a data processing method are provided. The display apparatus includes: a display, a user input interface, a communicating device, a memory, and at least one processor configured to execute computer instructions to cause the display apparatus to: collect a first voice input from a first user while a translation function is activated; convert the first voice into first text; determine a language and a first text feature corresponding to the first text by analyzing the first text; based on that the first text corresponds to a first language, set a second language as a target language, and translate the first text into second text in the second language through the translation function according to the first text feature, determine a first instruction corresponding to the second text by parsing the second text; and execute an operation corresponding to the first instruction.

### CROSS-REFERENCE TO RELATED APPLICATIONS

The disclosure is a national phase entry under 35 U.S.C § 371 of International Application No. PCT/EP2024/063333, filed May 15, 2024, which claims the priorities to Chinese Application No. 202310553341.0 filed on May 16, 2023 and Chinese Application No. 202410381050.2 filed on Mar. 29, 2024, which are incorporated in their entireties herein by reference.

### TECHNICAL FIELD

The disclosure relates to the technical field of a display apparatus, and in particular to a display apparatus and a data processing method.

### BACKGROUND

A display apparatus can be configured with a voice interaction function. Accordingly, a user can control the display apparatus with a voice command sent to the display apparatus instead of other control devices. In this way, the simplicity of user operations can be greatly improved, and a companion device of the display apparatus can be effectively simplified.

However, the display apparatus can support only a limited number of languages. If the user sends a voice command in a language that the display apparatus does not support, the display apparatus cannot accurately identify the voice command, and thus cannot satisfy the demand of the user. When playing music resources or video resources, the display apparatus can only play the music or video in a language that the user would not like to use if the music or video to be played does not support a language that the user would like to use.

### SUMMARY

The disclosure can provide a display apparatus. The display apparatus can include: a display configured to display an image and/or a user interface; a user input interface configured to receive a command from a user; a communicating device configured to communicate with an external device according to a predetermined protocol; a memory configured to save computer instructions and data associated with the display; and at least one processor in connection with the display, the user input interface, the communicating device, and the memory and configured to execute the computer instructions, so as to cause the display apparatus to: while a translation function is activated in the display apparatus, collect a first voice input from a first user; convert the first voice into first text; determine a language and a first text feature corresponding to the first text by analyzing the first text; based on that the first text corresponds to a first language, set a second language as a target language, and translate the first text into second text in the second language through the translation function according to the first text feature, where the display apparatus is configured to support an instruction in the second language instead of an instruction in the first language; determine a first instruction corresponding to the second text by parsing the second text; and in response to the first instruction, execute an operation corresponding to the first instruction.

The disclosure can further provide a data processing method for a display apparatus and including: while a translation function is activated in the display apparatus, collecting a first voice input from a first user; converting the first voice into first text; determining a language and a first text feature corresponding to the first text by analyzing the first text; based on that the first text corresponds to a first language, setting a second language as a target language, and translating the first text into second text in the second language through the translation function according to the first text feature, where the display apparatus is configured to support an instruction in the second language instead of an instruction in the first language; determining a first instruction corresponding to the second text by parsing the second text; and in response to the first instruction, executing an operation corresponding to the first instruction.

### BRIEF DESCRIPTION OF FIGURES

FIG. 1 shows a use scenario of a display apparatus according to some embodiments.

FIG. 2 is a block diagram of a configuration of a control device according to some embodiments.

FIG. 3 is a diagram of a configuration of a display apparatus according to some embodiments.

FIG. 4 is a diagram of a configuration of an operating system of a display apparatus according to some embodiments.

FIG. 5 is a flowchart for a display apparatus to respond to a voice from a user according to some embodiments.

FIG. 6 is a schematic diagram of a module of a display apparatus according to some embodiments.

FIG. 7 is a flowchart for a display apparatus to identify a first text feature according to some embodiments.

FIG. 8 is a flowchart for a display apparatus to respond to a first instruction according to some embodiments.

FIG. 9 is a flowchart for a display apparatus to translate a first subtext feature according to some embodiments.

FIG. 10 is a flowchart for a display apparatus to respond to a first instruction according to some embodiments.

FIG. 11 is a flowchart for a display apparatus to respond to a first instruction according to some embodiments.

FIG. 12 is a flowchart for a display apparatus to respond to a first instruction according to some embodiments.

FIG. 13 is a flowchart for a display apparatus to respond to a first instruction according to some embodiments.

FIG. 14 is a flowchart for a display apparatus to play a media resource in a user-designated language according to some embodiments.

FIG. 15 is a schematic diagram of a system menu including a media resource language option according to some embodiments.

FIG. 16 is a schematic diagram of a shortcut menu including a media resource language option according to some embodiments.

FIG. 17 is a schematic diagram of a language option page according to some embodiments.

FIG. 18 is a schematic block diagram of a flow for a display apparatus to translate a media file according to some embodiments.

FIG. 19 is a schematic flowchart for a display apparatus to translate a media file according to some embodiments.

FIG. 20 is a schematic flowchart for a display apparatus to set a translation category according to some embodiments.

FIG. 21 is a schematic diagram of a translation category selection page according to some embodiments.

FIG. 22 is a schematic flowchart for a display apparatus to determine a target language according to some embodiments.

FIG. 23 is a schematic flowchart for a display apparatus to translate an audio data source into translation text in a target language according to some embodiments.

FIG. 24 is a schematic flowchart for a display apparatus to extract semantic audio information from valid audio information according to some embodiments.

FIG. 25 is a schematic diagram of an effect generated when a display apparatus displays prompt information that no translation criterion is satisfied according to some embodiments.

FIG. 26 is a schematic diagram a prompt effect generated when a display apparatus displays that no human sound information exists according to some embodiments.

FIG. 27 is a schematic flowchart for a display apparatus to divide semantic audio information into audio sentences having a preset length according to some embodiments.

FIG. 28 is a schematic flowchart for a display apparatus to translate a text data source into translation text in a target language according to some embodiments.

FIG. 29 is a summary chart of a block for a display apparatus to execute a data processing method according to some embodiments.

FIG. 30 is a schematic flowchart for a display apparatus to output translation text in a user interface according to some embodiments.

FIG. 31 is a schematic flowchart of a data processing method according to some embodiments.

### DETAILED DESCRIPTION

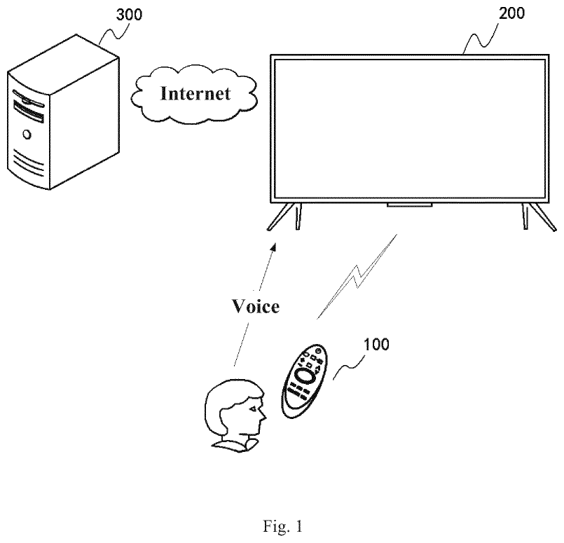

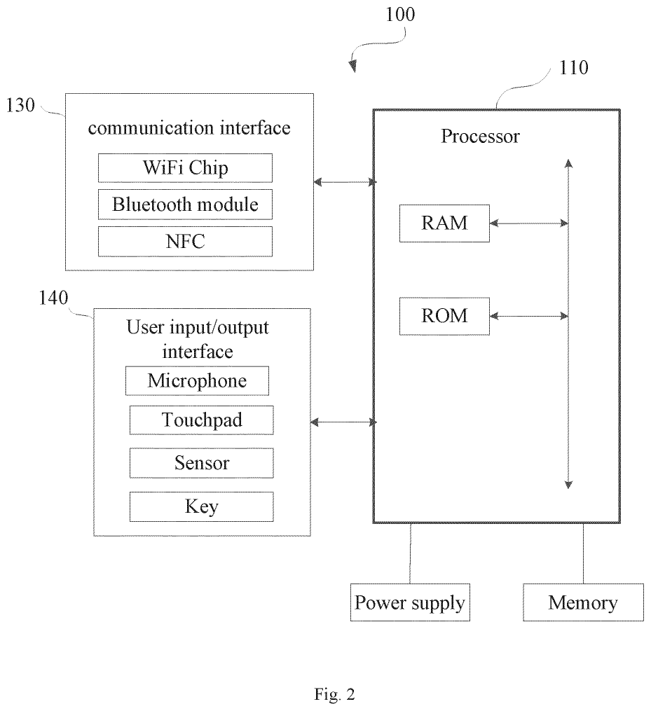

A display apparatus according to some embodiments of the disclosure may have various implementations. For example, it may a smart television, a laser projection device, a monitor, an electronic bulletin board, and an electronic table, or a device having a display screen, such as a mobile phone, a tablet computer, and a smart watch. FIGS. 1 and 2 show an implementation of the display apparatus of the disclosure.

FIG. 1 is a schematic diagram of a use scenario of a display apparatus 200 according to some embodiments. In some embodiments, as shown in FIG. 1, a user may send a key command to the display apparatus 200 through keys on a control device 100, to control the display apparatus 200. In some other embodiments, the user may control the display apparatus 200 by voice. For example, the user may control the display apparatus 200 to activate a voice interaction function by pressing a microphone key on the control device 100. After the voice interaction function is activated, the user may input a voice to the display apparatus 200 through a microphone on the control device 100. For another example, after a far-field voice interaction function of the display apparatus 200 is activated, the user may awaken the far-field voice interaction function of the display apparatus 200 by speaking a trigger word within a sound collection range of the display apparatus 200, and continue to utter a voice within the sound collection range of the display apparatus 200 while the display apparatus 200 is awakened. The display apparatus 200 may determine a corresponding instruction by analyzing the collected voice and respond to the instruction, to realize an effect that the user can control the display apparatus 200 by voice.

In some embodiments, the display apparatus 200 may obtain a live broadcast signal through a satellite. In some other embodiments, the display apparatus 200 may obtain network data through a server 300.

FIG. 2 is a block diagram of a configuration of the control device 100. In some embodiments, the control device 100 may be a remote controller. The communication between the remote controller and the display apparatus 200 may include at least one of infrared protocol communication, Bluetooth protocol communication, and other short-distance communication. The display apparatus 200 is controlled in a wireless or wired manner. The user may input a user command through a key, a voice input, a control panel input, etc. on the remote controller, so as to control the display apparatus 200. As shown in FIG. 2, the control device 100 may include: at least one processor 110, a communication interface 130, a user input/output interface 140, a memory, and a power supply. The control device 100 may receive an operation command input from the user, convert the operation command into an instruction that the display apparatus 200 may identify and respond to, and sent the operation command or an instruction obtained by converting a voice command to the display apparatus 200, so as to realize an effect of an interaction medium between the user and the display apparatus 200.

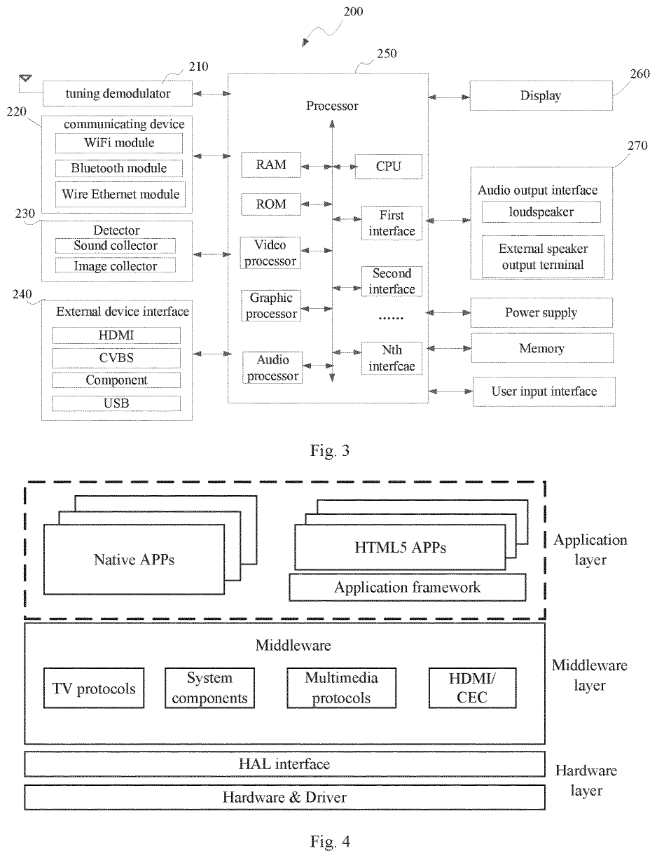

FIG. 3 is a block diagram of a configuration of a display apparatus 200 according to an illustrative embodiment.

The display apparatus 200 can include at least one of a tuning demodulator 210, a communicating device 220, a detector 230, an external device interface 240, a processor 250, a display 260, an audio output interface 270, a memory, a power supply, and a user input interface 280.

In some embodiments, transmission and reception of a control signal and a data signal between the display apparatus 200 and the control device 100 or the server 300 may be realized through the communicating device 220. In some embodiments, the detector 230 can include a sound collector. The display apparatus 200 may collect the voice of the user through the sound collector and send the collected voice to the processor 250 for processing, such as parsing out an instruction corresponding to the voice. In some embodiments, the processor 250 and the tuning demodulator 210 may be positioned in different individual devices, that is, the tuning demodulator 210 may also be positioned in an external device of a main device in which the processor 250 is positioned, such as an external set-top box. In some embodiments, the processor 250 can control the display apparatus to work and respond to operations from the user through various software applications stored on the memory. The processor 250 can control an overall operation of the display apparatus 200. In some embodiments, the processor 250 can include at least one processor, for example, a central processing unit (CPU), a video processing unit, an audio processing unit, a graphics processing unit (GPU), a random access memory (RAM), a read-only memory (ROM), a first interface to an nth interface for input/output, a communication bus, etc. In some embodiments, the display 260 can include a display panel component configured to display a page, a drive component configured to drive image display, a component configured to receive an image signal output from the processor 250 and display a video content, an image content, and a menu operation interface, and a user interface (UI) controlled by the user. In some embodiments, the display 260 may be a liquid crystal display, an organic light-emitting diode (OLED) display, or a projection display, and may further be a projection apparatus or a projection screen. In some embodiments, the user may input the user command in a graphical user interface (GUI) displayed on the display 260, and then the user input interface receives the command input from the user through the GUI. Alternatively, the user may input the user command by inputting a specific sound or gesture, and then the user input interface identifies the sound or gesture through a sensor, so as to receive the command input from the user.

In some embodiments, the display apparatus 200 may be based on a VIDDA software platform. As shown in FIG. 4, an operating system based on a Linux platform may be divided into three layers, i.e., an application layer, a middleware layer, and a hardware layer from top to bottom respectively. The application layer may include various applications and application frameworks. The middleware layer can include various protocols and components. The hardware layer can include various interfaces, hardware, and drivers.

Based on the voice interaction function of the display apparatus 200, the user may control the display apparatus 200 by sending a voice to the display apparatus 200 without other control devices 100, such as the remote controller, a mouse, and a keyboard. In this way, the simplicity of user operations can be greatly improved, and a companion device of the display apparatus 200 can be effectively simplified.

The display apparatus 200 may be limited by the place of sale, the standard, the regulations, etc., and has a limited number of the countries/regions supported. Therefore, when the display apparatus 200 is developed for a designated country/region, a language matched with the country/region supported is generally configured for the display apparatus 200 in consideration of a cost. Alternatively, some common languages are additionally configured for the display apparatus 200 on the basis of the foregoing language. Therefore, the display apparatus 200 has a limited number of supportable languages, and it is difficult to support all languages.

Therefore, if the user would like to perform voice interaction with the display apparatus 200 in a language that the display apparatus 200 does not support, the display apparatus 200 may not be able to accurately identify an instruction corresponding to a voice, and thus cannot accurately respond to the voice of the user or satisfy the demand of the user. For example, a merchant cannot sell a display apparatus 200 developed for country/region A to country/region B, otherwise a user in country/region B cannot normally use a voice interaction function of the display apparatus 200. For example, if the user who can only speak a language of country/region A goes to country/region B, since the display apparatus 200 used in country/region B is developed for country/region B, the voice interactive function of the display apparatus 200 may not be normally used.

In view of the above issues, the display apparatus 200 is configured with a translation function in the disclosure. Based on the translation function, after collecting a voice in a language that the display apparatus does not support, the display apparatus 200 may automatically translate text corresponding to the voice into a translation in a language that the display apparatus supports, accurately identify a corresponding instruction by parsing the translation, and accurately satisfy the demand of the user in response to the instruction.

Some embodiments of the disclosure will be described with the display apparatus 200 supporting an instruction in a second language instead of an instruction in a first language, and the user to control the display apparatus 200 currently being a first user as embodiments. The first language may include at least one language, and the second language may include at least one language.

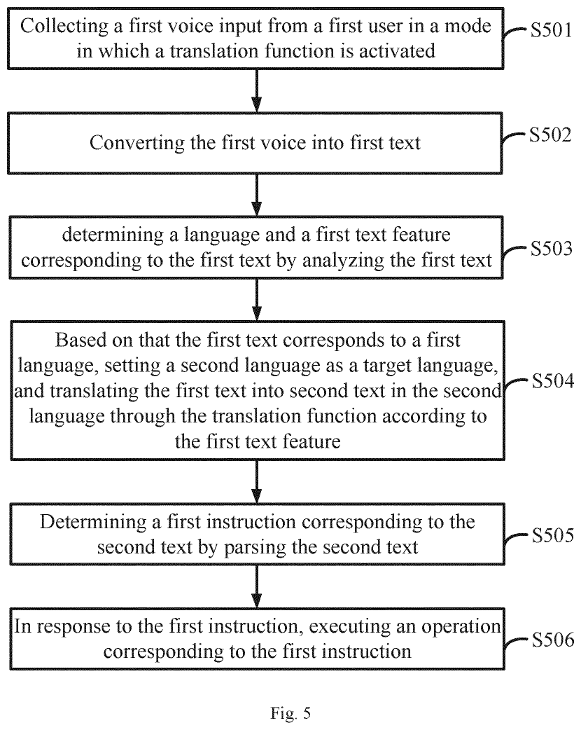

The display apparatus 200 may respond to the voice of the user according to a flow shown in FIG. 5 as follows.

S501, in a mode where the translation function is activated, collecting a first voice input from a first user.

In some embodiments, the display apparatus 200 may be configured to activate the translation function by default. In this way, the display apparatus 200 may automatically activate the translation function after being powered on.

In some embodiments, the display apparatus 200 may be configured to deactivate the translation function by default. In this way, the display apparatus 200 will not automatically activate the translation function after being powered on. If the user would like to use the voice interaction function and cannot input a voice in the second language, the user may control the display apparatus 200 to activate the translation function. For example, the user may control the display apparatus 200 to activate the translation function before using the voice interaction function.

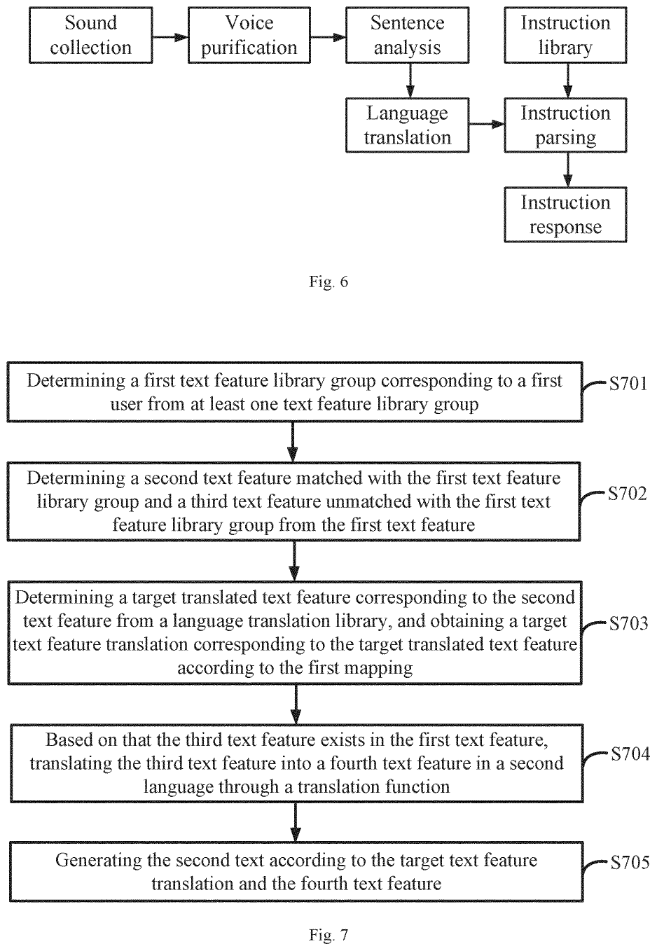

With reference to a schematic diagram of a module of the display apparatus 200 in FIG. 6, the display apparatus 200 may be configured with a sound collection module, so as to collect the voice through the sound collection module.

In some embodiments, the display apparatus 200 may collect the voice through the sound collector.

In some embodiments, the display apparatus 200 may receive the voice transmitted by the control device 100 and/or an external sound collection device. The control device 100 may include a remote controller, etc., and the external sound collection device may include a microphone, etc. The control device 100 and the external sound collection device may transmit the voice to the display apparatus 200 through a data network, Bluetooth (BT), infrared, etc.

In some embodiments, the display apparatus 200 may receive voices transmitted by other smart devices. Other smart devices may include a mobile phone, etc. Other smart devices may transmit the voice to the display apparatus 200 through a wireless transmission technology such as a digital living network alliance (DLNA), etc.

Since an environment around the display apparatus 200 may be noisy, the sound collected by the display apparatus 200 may include some interference except for the first voice made by the first user. These interferences may include a noisy environmental sound, such as environmental noise and an unhuman sound. These interferences may also include other human sounds. For example, there are other users around the first user to make sounds simultaneously with the first user. Alternatively, there is a device that may play a human sound around the first user, such as a mobile phone and a television, to play the human sound simultaneously with the first user. If the sound collected by the display apparatus 200 includes a large amount of interference, the accuracy of analyzing the first voice by the display apparatus 200 may be affected.

In order to reduce the interference included in the sound collected by the display apparatus 200, as shown in FIG. 6, the display apparatus 200 may be configured with a voice purification module, so as to remove the environmental sound from the collected voice and extract the first voice of the first user through the voice purification module.

In some embodiments, the voice purification module may identify the human sound and the environmental sound from the collected voice according to a spectral range, a timbre feature, etc. of the human sound, remove the environmental sound identified, and retain the human sound. For example, noise reduction may be performed on the collected voice through a Gaussian filter, etc.

In some embodiments, when the human sound identified can include a plurality of human sounds, the voice purification module may separate the human sounds identified according to distances of the sound sources. For example, a human sound having a shortest distance of sound source is extracted as the voice to be responded to.

In some embodiments, if the human sound having the shortest distance of the sound source is directly determined as the voice to be responded to, a voice of another user closer to the display apparatus 200 than the first user may be determined as the voice to be responded to mistakenly. In order to reduce the probability of the above error, the display apparatus 200 may be further configured to: display and/or play a prompt when the plurality of human sounds are identified. The prompt may be configured to prompt the user who would like to control the display apparatus 200 currently to move closer to the display apparatus 200. In this way, the first user may move to a position closer to the display apparatus 200 and/or ask another user to move a position further away from the display apparatus 200 according to the prompt. In this case, if the reply voice is determined according to the distance of the sound source, the first voice of the first user may be more accurately determined as the voice to be responded to, so that the response accuracy is improved.

S502, converting the first voice into first text.

The display apparatus 200 may convert a voice signal of the first voice into a digital feature for analysis, such as a spectrum, a sound intensity, and a pause of the first voice.

The display apparatus 200 identifies each phoneme, phrase or word according to the digital feature, to obtain the first text corresponding to the first voice. For example, the phoneme, phrase or word may be identified through an acoustic model.

S503, determining a language and a first text feature corresponding to the first text by analyzing the first text.

The display apparatus 200 may identify the language used in the first text, and an identification result may be the first language or the second language.

As shown in FIG. 6, the display apparatus 200 may be configured with a sentence analysis module. After the voice is collected and purified, the sentence analysis module performs sentence analysis on a purified voice, so as to obtain the first text feature corresponding to the first text.

In some embodiments, the first text feature may include characters, words, sentences, grammar, etc. in the first text.

In some embodiments, the display apparatus 200 may obtain the first text feature in the first text through the sentence analysis module according to a character library, a word library, a sentence library, a common expression library, a grammar library, etc. of the first language. For example, the sentences included in the first text may be obtained by dividing and segmenting the first text. The words included in the first text may be obtained by performing word formation analysis on each sentence. The grammar may be obtained by analyzing the sentences according to the sentences and the words. Semantics of the first text may be obtained by analyzing the sentences according to the sentences, the words, and the grammar.

S504, based on that the first text corresponds to the first language, setting the second language as a target language, and translating the first text into second text in the second language through the translation function according to the first text feature.

The target language is a language into which the first text is to be translated.

In some embodiments of the disclosure, since an instruction language supportable by the display apparatus 200 is the second language, the second language is set as the target language.

If the identification result is the first language, it is indicated that the display apparatus 200 does not support direct response to the instruction included in the first text. It is required to translate the first text into the target language, i.e., the second language, through the translation function firstly.

As shown in FIG. 6, the display apparatus 200 may be configured with a language translation module, so as to translate text representing sentence analysis into the target language through the language translation module.

In some embodiments, the display apparatus 200 is required to translate the first text into the second text in the second language, so as to obtain the instruction in the second language based on the second text. For example, the display apparatus 200 may transmit the first text features one by one to the language translation module. The language translation module translates each first text feature and integrates translations of all the first text features into the second text, i.e., a translation in the second language corresponding to the first text.

In some embodiments, the first text feature obtained in S503 may be stored.

Owing to different habits of using the voice interaction function, different users may use different sentence patterns. Owing to different demands, preferences, etc. of using the display apparatus 200, different users may use different keywords. In view of the above, text corresponding to voices input from different users (hereinafter referred to as text) can include different text features. In this way, the text feature obtained by analyzing the text according to a universal text feature library group may not accurately reflect use habits, use preferences, use demands, etc. of different users, which will also lead to the low accuracy of subsequent translation.

In view of the above issue, after the text feature of the text corresponding to the voice input from the user is obtained, the text feature of each user may be stored correspondingly, so as to obtain a text feature library group specific to each user. In this way, the display apparatus 200 may store at least one text feature library group, and the at least one text feature library group corresponds to different users respectively. Each text feature library group may include at least one text feature library. Each text feature library correspondingly stores a type of text features, such as a character library, a word library, a sentence library, a common word library, a grammar library, etc. specific to the user.

In some embodiments, based on the translation of the first text in S504, a correspondence relation between the first text feature in the first text and the translation (such as a translation corresponding to each word in the first text, a translation corresponding to each sentence in the first text, etc.) may be obtained. The display apparatus 200 may establish a mapping between the first text feature and the corresponding translation and store the mapping.

In some embodiments, with reference to the above process of establishing the mapping between the first text feature and the translation and storing the mapping, the display apparatus 200 may establish mappings between text features in text corresponding to a voice input from each user in any language (including the first language and the second language) and translations corresponding to these text features and store these mappings. A library storing these mappings may be referred to as a language translation library. The language translation library may be divided according to a language corresponding to a translated text feature and a target language corresponding to the translation or according to a target language corresponding to the translation. The text feature included in the text corresponding to the voice input from each user may be referred to as the translated text feature. Translations corresponding to these translated text features may be referred to as text feature translations. A mapping between the translated text features and the text feature translations may be referred to as a first mapping. In other words, the language translation library can include the first mapping between the translated text features and the text feature translations in the target language.

Based on the language translation library and at least one text feature library group, based on S503, the display apparatus 200 may further identify the first text feature according to a flow shown in FIG. 7 in combination with the specific text feature library group as follows.

S701, determining a first text feature library group corresponding to the first user from the at least one text feature library group.

The display apparatus 200 may determine the first corresponding text feature library group by analyzing the first voice of the first user.

For example, the display apparatus 200 may establish a second mapping between the timbre feature, etc. of the user and the text feature library group. In this way, after identifying the first voice of the first user, the display apparatus 200 may determine a corresponding text feature library group, i.e., the first text feature library group, based on the second mapping according to the timbre feature, etc. of the first voice.

S702, determining a second text feature matched with the first text feature library group and a third text feature unmatched with the first text feature library group from the first text feature.

A matched text feature and an unmatched text feature may be determined from the first text feature according to the text feature library included in the first text feature library group. For example, if the first text feature is a word, a matched word and an unmatched word may be determined from the first text feature according to the word library in the first text feature library group.

The second text feature denotes a translated text feature in the first text feature, and thus is not required to be translated in the translation process. The third text feature denotes an untranslated text feature in the first text feature, and thus is required to be translated in the translation process.

As shown in FIG. 7, the display apparatus 200 may translate the first text according to S703-S705 as follows.

S703, determining a target translated text feature corresponding to the second text feature from the language translation library, and obtaining a target text feature translation corresponding to the target translated text feature according to the first mapping.

It can be seen from the above process of constructing the language translation library that the translated text feature is a text feature included in the voice input from the user. It can be seen from the above process of constructing the text feature library group that the text feature in the text feature library group is also a text feature included in the voice input from the user. Therefore, the second text feature matched with the first text feature library group in the first text feature is also stored in the language translation library as the translated text feature and has a corresponding text feature translation. Therefore, for the second text feature, the language translation module may directly invoke a translated text feature, i.e., the target translated text feature, corresponding to the second text feature in the language translation library. After determining the target translated text feature, the language translation module may obtain the target text feature translation directly from the language translation library according to the first mapping. The target text feature translation is a translation of the second text feature.

S704, based on that the third text feature exists in the first text feature, translating the third text feature into a fourth text feature in the second language through the translation function.

When the third text feature exists, the language translation module translates the third text feature into the fourth text feature in the second language in the translation process. In other words, the fourth text feature is a translation of the third text feature.

S705, generating second text according to the target text feature translation and the fourth text feature.

A translation of all the first text features may be obtained by integrating the translation of the second text feature with the translation of the third text feature. In other words, a translation, i.e., the second text, of the first text may be obtained by integrating the target text feature translation with the fourth text feature.

It can be seen that based on the above process, when the display apparatus 200 automatically translates the first text, for the first text feature that has been translated in the first text, the corresponding translation may be directly invoked from the language translation library without being retranslated in the translation process. In the translation process, only the third text feature that has not been untranslated before in the first text is required to be translated, so that the translation efficiency can be effectively improved.

Based on the above process, in some embodiments, after the third text feature and the fourth text feature are obtained, a mapping is established between the third text feature and the fourth text feature with the third text feature as the translated text feature and the fourth text feature as the text feature translation, and the mapping is stored in the language translation library to iteratively update the language translation library.

S505, determining a first instruction corresponding to the second text by parsing the second text.

As shown in FIG. 6, the display apparatus 200 may be configured with an instruction library in the second language. The instruction library in the second language can include an instruction in the second language that the display apparatus 200 supports response. These instructions may be related to the brand of the display apparatus 200, etc.

As shown in FIG. 6, the display apparatus 200 may be configured with an instruction parsing module, so as to parse the first instruction in the second text through the instruction parsing module.

In some embodiments, the instruction parsing module may determine an instruction, matched with the instruction in the instruction library in the second language, in the second text, i.e., the first instruction.

In some embodiments, if the second text is too long, a process for the instruction parsing module to determine the first instruction in the second text according to the instruction library in the second language may further include: determining a text feature of the second text, such as a word, a sentence, grammar, semantics, etc., by analyzing the second text. Reference may be made to S503 for the process, which will not be repeated herein. The first instruction that can be matched is determined by matching the text feature of the second text with the instruction in the instruction library in the second language. The first instruction is an instruction in the second language.

The first instruction is an instruction indicated by the first user in the first voice.

S506, in response to the first instruction, executing an operation corresponding to the first instruction.

The display apparatus 200 responds to the first instruction, so as to satisfy the demand of the first user.

In some embodiments, one or a combination of several corresponding services provided by the voice purification module, the sentence analysis module, the language translation module, and the instruction parsing module may be implemented by cloud servers. The display apparatus 200 may implement the corresponding service by invoking the corresponding cloud server.

In some embodiments, one or a combination of several of a general text feature library group, a user-specific text feature library group, the language translation library, the instruction library in the second language, etc. may be stored in the cloud servers. The display apparatus 200 may invoke corresponding library data from the cloud server when in use.

In some embodiments, after the language corresponding to the first text is determined in S503, the flow further can include: based on that the first text corresponds to the second language, determining the first instruction according to the first text feature and the instruction library in the second language.

If the first text is determined to correspond to the second language, it is indicated that the display apparatus 200 supports direct response to the instruction in the first voice without translating the first text through the translation function. Reference may be made to S505 for a process for the display apparatus 200 to determine the first instruction according to the first text feature and the instruction library in the second language, which will not be repeated herein.

In some embodiments, the flow further can include, in response to the first instruction, executing an operation corresponding to the first instruction.

The display apparatus 200 responds to the first instruction, so as to satisfy the demand of the first user.

### Example 1

S501-S506 will be described with an instruction in the first language not supported by the display apparatus 200 being a Chinese instruction and an instruction in the second language supported by the display apparatus being an English instruction as an example.

The first user utters a first voice, such as the Chinese instruction “ [symbol] A (please play the movie A)”, in the vicinity of the display apparatus 200. After collecting the first voice through the sound collection module, the display apparatus 200 may purify the first voice through the voice purification module. The display apparatus 200 converts the first voice into first text “ [symbol] [symbol] A (please play the movie A)”. The display apparatus 200 may determine that the language used in the first voice is Chinese, i.e., the first language. The display apparatus 200 may obtain a first text feature of the first text, such as “ [symbol] (please)”, “ [symbol] (play)”, “ [symbol] A (the movie A)”, and a sentence pattern “please+verb+object”, through the sentence analysis module. The sentence analysis module may determine a first text feature library group corresponding to the first user. If the first text feature library group includes a word library, a sentence library, and a grammar library, where the word library can include “ [symbol] (please)” and “ [symbol] (play)”, and the sentence library can include “ [symbol] (please)+ [symbol] (verb)+ [symbol] (object)”, a second text feature matched with the first text feature library group in the first text feature may be determined as including “ [symbol] (please play)”, and a third text feature unmatched with the first text feature library group in the first text feature may be determined as including “ [symbol] A (movie A)”. The sentence analysis module transmits the first text features one by one to the language translation module for translation. The language translation module may invoke the language translation library. If the language translation library can include first mapping between a translated text feature “ [symbol] (please play)” and a text feature translation “please play”, the language translation module may determine the translated text feature “ [symbol] (please play)” as a target translated text feature corresponding to the second text feature “ [symbol] [symbol] (please play)”, and obtain a target text feature translation “please play” according to the first mapping. The language translation module translates the third text feature “ [symbol] A (the movie A)” into “the movie A” in English through the translation function. In this way, an English translation “Please play the movie A” of the first text “ [symbol] A (please play the movie A)” may be obtained rapidly. The display apparatus 200 may determine a first instruction corresponding to “Please play the movie A” through the instruction parsing module. For example, the display apparatus 200 may analyze “Please play the movie A” and match same with an English instruction library, so as to determine the first instruction. The first instruction may be an instruction that the display apparatus 200 supports response, such as “Play the movie A”.

In connection with some embodiments below, a process for the display apparatus 200 to respond to different first instructions issued by the first user will be discussed.

In some embodiments, the first voice may further include a first sentence, and the first instruction indicates translation of the first sentence into a first designated language. In other words, the first voice can include an instruction portion corresponding to the first instruction and the first sentence. The first sentence may be input from the first user in any language (including the first language and the second language). In this way, the first user may instruct the display apparatus 200 to translate the first sentence in any language into the first designated language through the first voice. Reference may be made to the above embodiment for a process of identifying the first instruction in the first voice.

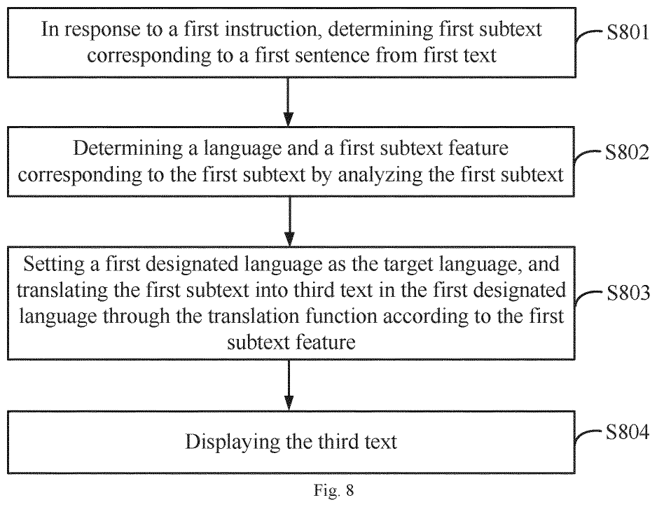

The display apparatus 200 may respond to the first instruction according to a flow shown in FIG. 8 as follows.

S801, in response to the first instruction, determining first subtext corresponding to the first sentence from the first text.

The sentence analysis module may extract the first subtext corresponding to the first sentence from the first text.

S802, determining a language and a first subtext feature corresponding to the first subtext by analyzing the first subtext.

S803, setting a first designated language as the target language, and translating the first subtext into third text in the first designated language through the translation function according to the first subtext feature.

Reference may be made to S503-S504 for S802-S803, which will not be repeated herein.

In a process of translating the first sentence, since the language into which the first sentence is to be translated is the first designated language, the display apparatus 200 is required to set the first designated language as the target language.

The first designated language is different from a language used by the first user for inputting the first sentence and may include the first language and the second language. In other words, the first user may translate the first sentence in any language into any another language through the display apparatus 200.

S804, displaying the third text.

A display mode of the third text may include one or a combination of several of text display, audio playing, picture display, animation display, etc.

In some embodiments, the display apparatus 200 may determine the display mode based on user settings, default system settings, device types, etc. For example, if the user setting is to display a text and audio, the display apparatus 200 may determine that an employed mode is text display+audio playing. For another example, if a currently-used device is a non-display apparatus, such as a smart headset, the apparatus may determine that an employed mode is audio playing.

After the display mode is determined, a display content corresponding to the mode is generated and displayed.

For example, if the display mode can include text display and audio playing, a corresponding text content and audio are generated according to the third text, the text content is displayed in the user interface, and the audio is played.

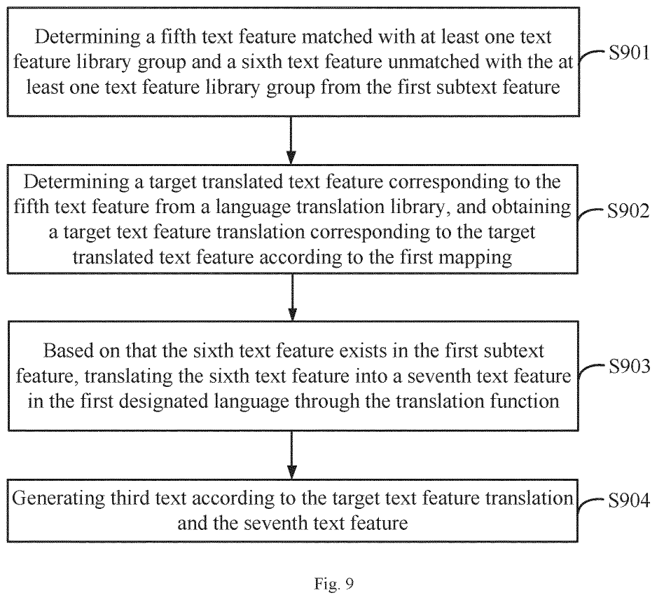

In some embodiments, after determining the first subtext feature corresponding to the first subtext, the display apparatus 200 may further translate the first subtext feature based on the language translation library and the text feature library group. The display apparatus 200 may translate the first subtext feature according to a flow shown in FIG. 9 as follows.

S901, determining a fifth text feature matched with the at least one text feature library group and a sixth text feature unmatched with the at least one text feature library group from the first subtext feature.

The display apparatus 200 may match the first subtext feature with all text feature library groups or match the first subtext feature with the first text feature library group corresponding to the first user.

Reference may be made to a process of matching and determining the second text feature in S702 for a process of matching and determining the fifth text feature, and reference may be made to a process of matching and determining the third text feature in S702 for a process of matching and determining the sixth text feature, which will not be repeated herein.

S902, determining a target translated text feature corresponding to the fifth text feature from the language translation library, and obtaining a target text feature translation corresponding to the target translated text feature according to the first mapping.

S903, based on that the sixth text feature exists in the first subtext feature, translating the sixth text feature into a seventh text feature in the first designated language through the translation function.

S904, generating the third text according to the target text feature translation and the seventh text feature.

Reference may be made to S703-S705 for S902-S904, which will not be repeated herein.

In this way, when the first sentence is translated, only an untranslated text feature (i.e., the sixth text feature) in the first sentence is required to be translated without retranslating a translated text feature (i.e., the fifth text feature) in the first sentence, so that the translation efficiency can be effectively improved.

### Example 2

Example 2 is described with an instruction in the first language not supported by the display apparatus 200 being a Chinese instruction and an instruction in the second language supported by the display apparatus being an English instruction as an example.

The first user utters a first voice, such as “ [symbol] ’ [symbol] (please translate ‘I like studying’ into English)”, in the vicinity of the display apparatus 200. The display apparatus 200 may convert the first voice into first text and determine a corresponding first instruction, such as “translate [symbol] (I like studying) into English” by analyzing the first text, and the process may be referred to in Example 1 and will not be repeated herein. The display apparatus 200 extracts first subtext, such as “ [symbol] (I like studying)”, corresponding to a first sentence from the first text in response to the first instruction. The display apparatus 200 may determine that the first subtext corresponds to Chinese and determine a first subtext feature corresponding to the first subtext by analyzing the first subtext. The display apparatus 200 sets English as a target language and translates “ [symbol] (I like studying)” into third text in English, such as “I like studying” through the translation function according to the first subtext feature. The display apparatus 200 may translate the first subtext feature rapidly according to the language translation library and the text feature library group. Reference may be made to Example 1 for the above process of translating the first subtext feature, which will not be repeated herein.

If the user setting is to display the third text through text display and audio playing, the display apparatus 200 may generate a corresponding text content and audio according to “I like studying”. The display apparatus 200 may display the text content in a corresponding user interface and play the audio.

In this way, the user may translate the first sentence input in any language into the first designated language through the display apparatus 200 for language learning.

In some other embodiments, the first voice may further include a second sentence and a third sentence, and the first instruction indicates a translation error generated when the third sentence is taken as a translation of the second sentence. In other words, the first voice can include an instruction portion corresponding to the first instruction, the second sentence, and the third sentence. The second sentence may be input from the first user in any language (including the first language and the second language). The third sentence may be input from the first user in any language (including the first language and the second language). In this way, the first user may instruct the display apparatus 200 to correct an error in the second sentence input in any language using the third sentence translated in any another language through the first voice. Reference may be made to the above embodiments for a process of identifying the first instruction in the first voice.

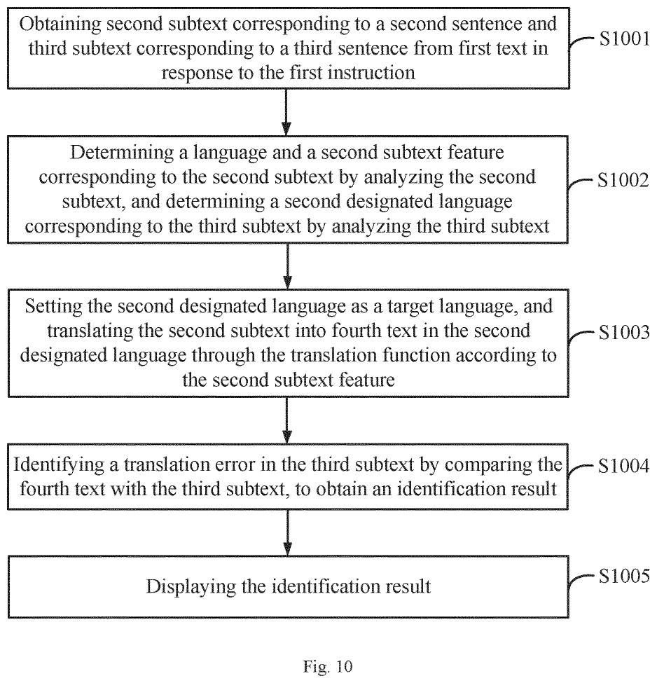

The display apparatus 200 may respond to the first instruction according to a flow shown in FIG. 10 as follows.

S1001, obtaining second subtext corresponding to the second sentence and third subtext corresponding to the third sentence from the first text in response to the first instruction.

S1002, determining a language and a second subtext feature corresponding to the second subtext by analyzing the second subtext, and determining a second designated language corresponding to the third subtext by analyzing the third subtext.

S1003, setting the second designated language as a target language, and translating the second subtext into fourth text in the second designated language through the translation function according to the second subtext feature.

Since it is required to determine whether the third sentence in the second designated language is correct, the second subtext is required to be translated into the second designated language firstly, so as to obtain a standard translation. Accordingly, in a process of translating the second subtext, it is required to set the second designated language as the target language.

Reference may be made to S801-S803 for S1001-S1003, which will not be repeated herein.

S1004, identifying a translation error in the third subtext by comparing the fourth text with the third subtext, to obtain an identification result.

The sentence analysis module may determine a text feature corresponding to the fourth text and a text feature corresponding to the third subtext, compare the text feature corresponding to the fourth text with the text feature corresponding to the third subtext, and determine a text feature different from the text feature corresponding to the fourth text from the text feature of the third subtext, i.e., a questionable text feature.

In some embodiments, the questionable text feature may be taken as a translation error in the third subtext.

In some embodiments, whether the questionable text feature is the translation error may be further identified according to a language translation library corresponding to the second designated language. For example, if the questionable text feature is identified as a text feature associated with a corresponding text feature in the fourth text and expressed correctly, such as a synonym expressed correctly, the questionable text feature is not determined as the translation error. If the questionable text feature is identified as a text feature not associated with a corresponding text feature in the fourth text or expressed incorrectly, the questionable text feature is determined as the translation error.

If no translation error is identified, the identification result may indicate that no error is identified. If the translation error is identified, the identification result may indicate that the error is identified. The identification result may also include an identified translation error, such as a grammar error and a word error.

S1005, displaying the identification result.

Reference may be made to S804 for a display mode of the identification result, which will not be repeated herein.

In some embodiments, if the identification result indicates that no error is identified, it is prompted that no error exists when the identification result is displayed. If the identification result indicates that the error is identified, it is prompted that the error exists when the identification result is displayed.

In some embodiments, if the identification result indicates that the error is identified, the display apparatus 200 obtains the identified translation error and corrects the identified translation error, so as to obtain the fifth text having the error corrected. The display apparatus 200 may display the identified error and the fifth text. For example, the display apparatus 200 may display the third subtext in a form of a character, mark the identified translation error in the third subtext, and display the fifth text below the third subtext. For another example, the display apparatus 200 may describe the identified translation error in the third subtext through audio playing and play audio corresponding to the fifth text.

### Example 3

Example 3 is illustratively described with an instruction in the first language not supported by the display apparatus 200 being a Chinese instruction and an instruction in the second language supported by the display apparatus being an English instruction as an example.

The first user utters a first voice, such as “ [symbol] [symbol] I like study [symbol] ?(The English translation of ‘ [symbol] (I like studying)’ is ‘I like study’, right?)”, in the vicinity of the display apparatus 200. The display apparatus 200 may convert the first voice into first text and determine a corresponding first instruction by analyzing the first text. Reference may be made to Example 1 for the process, which will not be repeated herein. The display apparatus 200 may extract second subtext “ [symbol] (I like studying)” corresponding to a second sentence and third subtext “I like study” corresponding to a third sentence from the first text in response to the first instruction. The display apparatus 200 may determine that the second subtext corresponds to Chinese, determine a second subtext feature corresponding to the second subtext by analyzing the second subtext, and determine that the third subtext corresponds to English by analyzing the third subtext. The display apparatus 200 sets English as a target language and translates “ [symbol] (I like studying)” into fourth text in English, such as “I like studying” through the translation function according to the second subtext feature. The display apparatus 200 may translate the second subtext feature rapidly according to the language translation library and the text feature library group. For the above process of translating the second subtext feature, please refer to Example 1, which will not be repeated herein. The display apparatus 200 may determine a questionable text feature, such as “study”, in the third subtext by comparing the fourth text with the third subtext. The display apparatus 200 may further identify the questionable text feature according to an English language translation library. The display apparatus 200 may determine that “study” is a text feature associated with a corresponding text feature “studying” in the fourth text but expressed incorrectly, and may determine that the questionable text feature is a translation error in the third subtext, so as to obtain an identification result. The identification result may include that an error is identified, may further include an identified translation error, such as “study”, and may further include fifth text having an error corrected, such as “I like studying”. In some embodiments, the identification result may further include an expression similar to the fifth text, such as “I like learning”. The display mode of the identification result by the display apparatus 200 may be referred to in Example 2 and will not be repeated herein.

In this way, the user may correct the error in the third sentence translated in any language through the display apparatus 200 for language learning.

In some embodiments, the first voice may further include a fourth sentence, and the first instruction indicates the correction of an error in the fourth sentence. In other words, the first voice can include an instruction portion corresponding to the first instruction and the fourth sentence. The fourth sentence may be input from the first user in any language (including the first language and the second language). In this way, the first user may instruct the display apparatus 200 to correct the error in the fourth sentence in any language through the first voice. The process of identifying the first instruction in the first voice may be referred to the above implementation for.

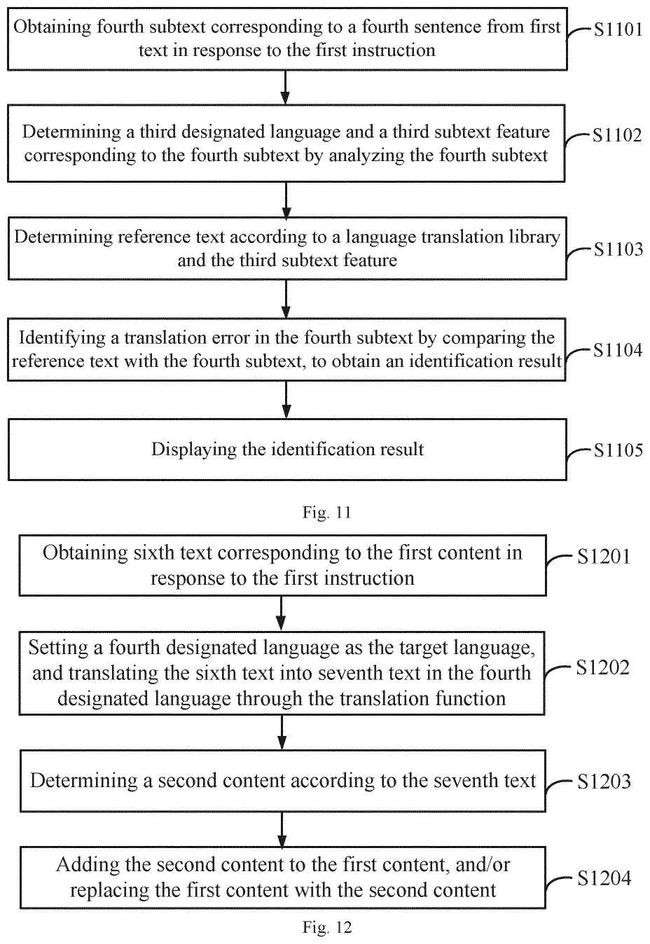

The display apparatus 200 may respond to the first instruction according to a flow shown in FIG. 11 as follows.

S1101, obtaining fourth subtext corresponding to the fourth sentence from the first text in response to the first instruction.

S1102, determining a third designated language and a third subtext feature corresponding to the fourth subtext by analyzing the fourth subtext.

Reference may be made to S1001-S1002 for S1101-S1102, which will not be repeated herein.

S1103, determining reference text according to the language translation library and the third subtext feature.

If a language translation library in the third designated language can include a text feature similar to the third subtext feature, such as a similar sentence pattern, a similar word, etc., the reference text matched with the third subtext feature may be determined according to these text feature s in combination with the third subtext feature.

If a language translation library in the third designated language does not include a text feature similar to the third subtext feature, the reference text matched with the third subtext feature may be determined according to the language translation library in the third designated language, such as text feature s of the third designated language, a use method and grammar of each text feature, etc.

S1104, identifying a translation error in the fourth subtext by comparing the reference text with the fourth subtext, to obtain an identification result.

S1105, displaying the identification result.

Reference may be made to S1004-S1005 for S1104-S1105, which will not be repeated herein.

### Example 4

Example 4 is described with an instruction in the first language not supported by the display apparatus 200 being a Chinese instruction and an instruction in the second language supported by the display apparatus being an English instruction as an example.

The first user utters a first voice, such as “ [symbol] I like study [symbol] (correcting the error in ‘I like study’)”, in the vicinity of the display apparatus 200. The display apparatus 200 may convert the first voice into first text and determine a corresponding first instruction by analyzing the first text. The process may be referred to Example 1, which will not be repeated herein. The display apparatus 200 may extract the fourth subtext “I like study” corresponding to a fourth sentence from the first text in response to the first instruction. The display apparatus 200 may determine that the fourth subtext corresponds to English and determine a third subtext feature corresponding to the fourth subtext by analyzing the fourth subtext. If the English language translation library can include a text feature, such as “I like swimming”, it can be determined that the English language translation library can include a text feature similar to the third subtext feature, such as “I like”, and the reference text may be determined as “I like studying” according to the text feature in combination with the third subtext feature. The display apparatus 200 may determine an error in the fourth subtext by comparing the reference text with the fourth subtext, and display an identification result. Reference may be made to Example 3 for the process, which will not be repeated herein.

In this way, the user may correct the error in the fourth sentence input in any language through the display apparatus 200 for language learning.

In some embodiments, the display apparatus 200 may establish a mapping between a sixth text feature and a seventh text feature and store the mapping in the language translation library in the first designated language, so as to update the language translation library in the first designated language.

In some embodiments, the display apparatus 200 may establish a mapping between the first subtext feature and the target translated text feature and the seventh text feature, and/or establish mapping between the first subtext and the third text, and store the mapping established in a separate library, which may be referred to as a “new word library”. In this way, the user may repeatedly learn the text feature s that have been translated through the translation function based on the “new word library”.

In some embodiments, the display apparatus 200 may establish a mapping between the questionable text feature and the fifth text, or establish a mapping between the third subtext as well as the questionable text feature and the fifth text, and store the mapping in a separate library, which may be referred to as an “error library”.

In some embodiments, the display apparatus 200 may establish a mapping between the questionable text feature and the fifth text, or establish a mapping between the fourth subtext as well as the questionable text feature and the fifth text, and store the mapping in the “error library”. In this way, the user may repeatedly learn the text features that have been translated incorrectly based on the “error library”.

The display apparatus 200 is configured with a basic audio and video playing function. For example, playing an existing audio and video resource. If the audio and video resource does not support the language that the user would like to use, the display apparatus 200 may only play the audio and video resource in a language that the user would not like to use. Moreover, the user may edit audio and video with the aid of an auxiliary tool, such as a third-party editing application. With the audio and video resource imported and exported, an editing process is not flexible enough. In view of the above issues, the display apparatus 200 may be configured with an audio and video translation function and an audio and video editing function, so that the user may perform customized translation and editing on the audio and video that is played.

In some embodiments, the first instruction indicates translation of a first content in first audio and video in a fourth designated language. The first content may include an audio portion and/or a text portion of the first audio and video.

The display apparatus 200 may respond to the first instruction according to a flow shown in FIG. 12 as follows.

S1201, obtaining sixth text corresponding to the first content in response to the first instruction.

The display apparatus 200 may extract the first content from the first audio and video by decoding an audio stream and/or a video stream. After extracting the first content, the display apparatus 200 can convert the first content into the corresponding sixth text. If the first content is the text portion, the text portion may be directly taken as the sixth text. If the first content is the audio portion, the audio portion is converted into the sixth text. Reference may be made to S502 for a process of converting the audio into the text, which will not be repeated herein.

S1202, setting the fourth designated language as a target language, and translating the sixth text into seventh text in the fourth designated language through the translation function.

Reference may be made to S504 for S1202, which will not be repeated herein.

In some embodiments, if the first content can include an audio portion and a text portion, a fourth instruction language corresponding to the audio portion may be consistent with or different from a fourth designated language corresponding to the text portion.

S1203, determining a second content according to the seventh text.

For example, if the first content can include the audio portion, the seventh text may be processed into audio through a sound processor, so as to obtain the second content.

For another example, if the first content can include the text portion, the seventh text may be processed into a new text portion, so as to obtain the second content.

S1204, adding the second content to the first content, and/or replacing the first content by the second content.

If the second content can include an audio portion, a corresponding audio portion in the first audio and video may be replaced by a new audio portion. In this way, when the first user plays the first audio and video through the display apparatus 200, the audio after replacement will be played when the portion is to be played.

Alternatively, the new audio portion may be added to the first content in the first audio and video. In this way, when the first user plays the first audio and video through the display apparatus 200, audio after addition will be played when the portion is to be played. If the original audio still exists in the portion, the original audio will also be played.

If the second content includes a text portion, a corresponding text portion in the first audio and video may be replaced by a new text portion. In this way, when the first user plays the first audio and video through the display apparatus 200, the text after replacement will be displayed when the portion is to be played.

Alternatively, the new text portion may be added to the first content in the first audio and video. In this way, when the first user plays the first audio and video through the display apparatus 200, the text after addition will be displayed when the portion is to be played. If an original text still exists in the portion, the original text will also be displayed.

### Example 5

Example 5 is described with an instruction in the first language not supported by the display apparatus 200 being a Chinese instruction and an instruction in the second language supported by the display apparatus being an English instruction as an example.

The display apparatus 200 plays first audio and video in the first language, such as first audio and video in Spanish. The first audio and video can include an audio portion and a text portion in Spanish. The first user sends a first voice, such as “ [symbol] [symbol] , [symbol] [symbol] (switching the audio to English, and switching the text to Chinese)”, in the vicinity of the display apparatus 200. The display apparatus 200 may convert the first voice into first text and determine a corresponding first instruction by analyzing the first text. This process may be referred to Example 1, which will not be repeated herein. The display apparatus 200 obtains the sixth text corresponding to a first content in response to the first instruction. The first content can include an audio portion and a text portion. The display apparatus 200 translates a sixth text portion corresponding to the audio portion into seventh text in English and translates a sixth text portion corresponding to the text portion into the seventh text in Chinese through the translation function. The above translation process may be referred to Example 1, which will not be repeated herein. The display apparatus 200 determines a second content according to the seventh text, where the seventh text in English is produced as a new audio portion, and the seventh text in Chinese is produced as a new text portion. An original audio portion in the first audio and video is replaced by the new audio portion, and an original text portion in the first audio and video is replaced by the new text portion. In this way, when the display apparatus 200 plays the first audio and video, the audio in English may be played, and the text in Chinese may be displayed.

In some embodiments, the first voice may further include a fifth sentence, and the first instruction indicates translation of the fifth sentence into a fifth designated language and editing of a third content of second audio and video. In other words, the first voice can include an instruction portion corresponding to the first instruction and the fifth sentence. The fifth sentence may be input from the first user in any language (including the first language and the second language). The second audio and video may include an audio portion and/or a text portion, or include no text content. The third content may be the audio portion and/or the text portion. In this way, the first user may translate the fifth sentence in any language into the fifth designated language through the display apparatus 200, and edit the second audio and video through the fifth sentence.

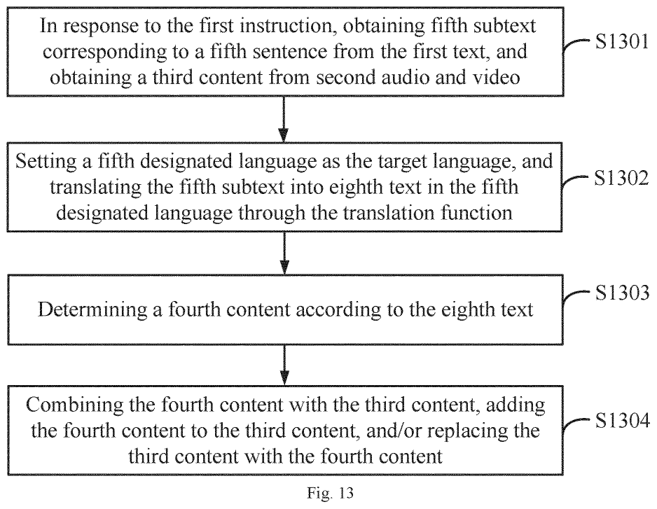

The display apparatus 200 may respond to the first instruction according to a flow shown in FIG. 13 as follows.

S1301, in response to the first instruction, obtaining fifth subtext corresponding to the fifth sentence from the first text, and obtaining the third content from the second audio and video.

The process for the display apparatus 200 to obtain the fifth subtext may be referred to S801, and the process for the display apparatus 200 to obtain the third content may be referred to S1201, which will not be repeated herein.

S1302, setting the fifth designated language as a target language, and translating the fifth subtext into eighth text in the fifth designated language through the translation function.

Reference may be made to S504 for S1302, which will not be repeated herein.

S1303, determining a fourth content according to the eighth text.

S1304, combining the fourth content with the third content, adding the fourth content to the third content, and/or replacing the third content by the fourth content.

Reference may be made to S1203-S1204 for S1303-S1304, which will not be repeated herein.

The fourth content is combined with the third content, so as to realize an effect of merging the fourth content with the third content. For example, the third content is unhuman sound audio, the fourth content is human sound audio, and human sound-containing audio may be obtained by combining the fourth content with the third content.

### Example 6

Example 6 is described with an instruction in the first language not supported by the display apparatus 200 being a Chinese instruction and an instruction in the second language supported by the display apparatus being an English instruction as an example.

The display apparatus 200 plays the second audio and video, where the second audio and video can include no text content. The first user sends a first voice, such as “ [symbol] [symbol] , [symbol] [symbol] (translating ‘ [symbol] [symbol] (today is a wonderful day)’ into English and add as an audio part and a text part)”, in the vicinity of the display apparatus 200. The display apparatus 200 may convert the first voice into first text and determine a corresponding first instruction by analyzing the first text, and this process may be referred to Example 1, which will not be repeated herein. The display apparatus 200 extracts fifth subtext corresponding to a fifth sentence, such as “ [symbol] [symbol] (today is a wonderful day)”, from the first text in response to the first instruction. The process of setting the fifth designated language English as the target language, translating the fifth subtext into eighth text in English, and determining a fourth content according to the eighth text may be referred to Example 5, which will not be repeated herein. The display apparatus 200 combines the fourth content with a third content of the second audio and video, In a case of playing the combined second audio and video, when playing an original sound of the second audio and video, the display apparatus 200 may also play audio “today is a wonderful day” and display corresponding texts.

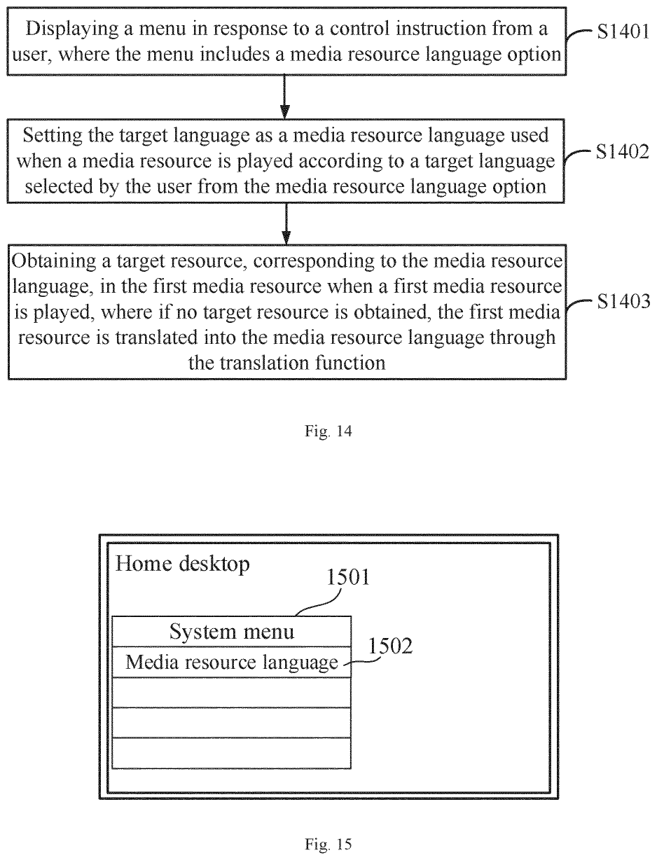

In some embodiments, the user may manually set a language used when a media resource is played. The display apparatus 200 may play the media resource in a user-designated language according to a flow shown in FIG. 14 as follows.

S1401, in response to a command from the user, displaying a menu, where the menu includes a media resource language option.

The user may input a command through a setting key, a menu key, a direction key, etc. on the control device 100. The command can be configured to indicate the display of a corresponding menu, such as a system menu and a shortcut menu.

In some embodiments, the user may input a command to the display apparatus 200 when the display apparatus 200 is not playing media resource. For example, as shown in FIG. 15, when displaying a home desktop, the display apparatus 200 displays a system menu 1501 in response to the command from the user. The system menu 1501 can include a media resource language option 1502.

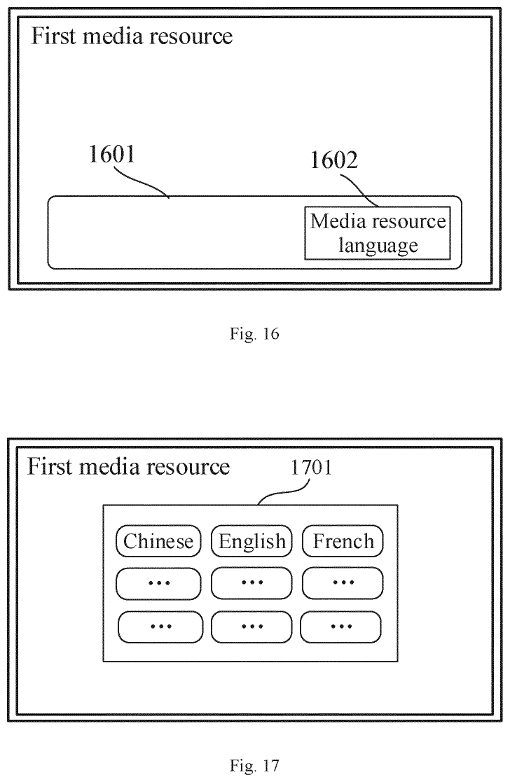

In some embodiments, the user may input a command to the display apparatus 200 when the display apparatus 200 is playing the media resource. For example, as shown in FIG. 16, when playing a first media resource, the display apparatus 200 displays a shortcut menu 1601 in response to the command from the user. The shortcut menu 1601 can include a media resource language option 1602.

In some embodiments, the media resource language option may be in a form of a drop-down list. The drop-down list may include options for global languages.

In some embodiments, if the media resource language option is in the form of the drop-down list, language options in the drop-down list may be arranged according to whether the media resource is played currently.

If no media resource is played currently, all the language options may be arranged in a default order, an order of preferentially displaying a language option of the country/region where the display apparatus is positioned, or an order of preferentially displaying a language in an instruction in a language that the display apparatus 200 supports response.

If the media resource, such as the first media resource, is played currently, all the language options may be arranged in an order of preferentially displaying a language of the first media resource that can be obtained by the display apparatus 200. For example, when the user selects the media resource language option 1602 in FIG. 16, the display apparatus 200 may display a language option page, for example, a language option page 1701 shown in FIG. 17. If the languages of the first media resource that can be obtained by the display apparatus 200 can include Chinese, English, and French, options for Chinese, English, and French may be preferentially displayed, and other language options may be displayed thereafter, as shown in FIG. 17. In this way, the user may preferentially set a media resource language to be used from the languages that the display apparatus 200 may directly obtain.

In some embodiments, the media resource language option may be in a form of an input box. The input box may be configured such that the user inputs the language intended to be set.

S1402, setting the target language as the media resource language used when the media resource is played according to the target language selected by the user from the media resource language options.

The target language is the media resource language that the user would like to use.

S1403, obtaining a target resource, corresponding to the media resource language, in the first media resource when the first media resource is played. If no target resource is obtained, the first media resource is translated into the media resource language through the translation function.

When playing the first media resource, if the display apparatus 200 identifies that the user has set the media resource language, it first obtains the target resource, corresponding to the media resource language, of the first media resource. For example, whether the first media resource itself may provide the media resource language is identified. If no, the target resource may be obtained through the Internet.

If the display apparatus 200 does not obtain target resource, in order to satisfy the language demand of the user, the first media resource may be translated into the media resource language through the translation function. Reference may be made to Example 5 for a translation process, which will not be repeated herein.

Therefore, the display apparatus 200 may provide the user with a language translation function, a language learning function, an audio and video editing function, and an audio and video translation function, so as to provide richer services for the user through the translation function.

In addition, considering that when the user views a media file on the display apparatus, if the media file that is playing is in a foreign language or another language that the user cannot directly understand, it is impossible for the user to directly understand a specific content played in the media file. In this case, the user may choose to view a translated version at a cinema or look up the translated version of the media file online. However, when viewing the translated version at a cinema, the media file provided at the cinema is generally incomplete, and even when the translated version of the media file is available, the playing time is limited. When searching for the translated version in the foreign language or another language of the media file online, the user may fail to find the media file or cannot view a specific content of the media file.

For example, for a new movie in a foreign language or another language, since only the cinema can offer a Chinese version “cinema-version translation”, the user can only view the movie at the cinema with a ticket. If all tickets of the cinema are sold out, or the cinema does not arrange a slot for the new movie during the holiday of the user, the user has to look up a resource in the translated version online. A large amount of time and effort will be consumed and even no resource is found if the user wants to find a clear version in a native language. In consequence, the user still cannot directly understand a specific content of the new movie.

In addition, the user may also translate the media file in the foreign language or another language through some translation software or translation tools. However, these translation software or translation tools can only translate surface meanings of expressions in the foreign language or another language, without analysis of specific scenarios. Moreover, the translation tools are limited to text-to-text translation, and thus cannot realize voice-to-text translation, which may lead to a low translation accuracy rate.

For example, when going to a different place for business or tourism, the user views a program of a local radio station on television. In consequence, the user cannot directly understand meanings of expressions in a local language. Especially for some persons who know nothing about the foreign language or another language that the user cannot understand directly, meanings that the program and media in the foreign language or another language express cannot be known. Even for persons who know a little about the foreign language or another language, since they are not familiar with local cultural differences, local speaking habits, etc., and thus cannot accurately understand the true meanings. If a translation tool such as translation software is used, text in the foreign language or another language can only be translated into desired text. However, in lack of semantic scenarios, etc., translation results may also be inaccurate, that is, the translation accuracy rate is low. Moreover, since the translation tools are limited to text-to-text translation and cannot realize voice-to-text translation, there may be a situation where the media file may fail to be translated.

In view of the above, in some embodiments of the disclosure, the display apparatus 200 may also automatically translate a media content in a language that the user cannot understand into a voice or text in a target language that the user can understand according to user settings, and synchronously display thereof on the media file played in a form of the voice and/or the text. In this way, the display apparatus 200 may automatically translate all the programs played in the foreign language into the target language. Accordingly, the user can rapidly understand the content of the media file that is displayed without translating the programs through the translation tools or searching for a file source in the target language online. Moreover, the user may select different output modes according to different scenarios, so that the user may make a selection according to different scenarios.

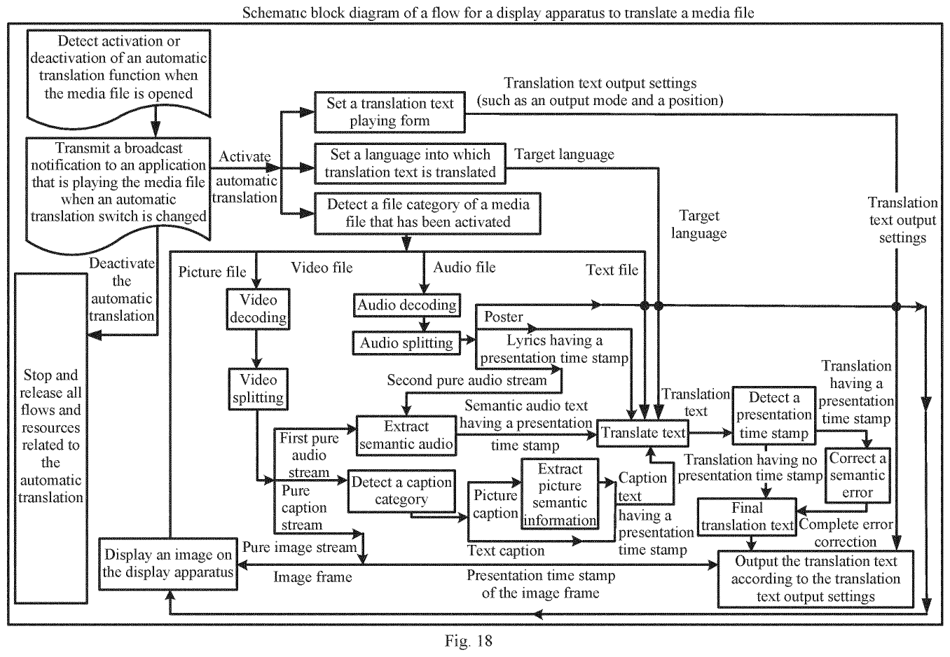

FIG. 18 is a schematic block diagram of a flow for a display apparatus to translate a media file according to some embodiments of the disclosure. As shown in FIG. 18, in some embodiments, in order to activate the translation function, the display apparatus 200 may be provided with a function control configured to activate or deactivate the translation function. The function control can be configured to control the automatic translation function to be activated or deactivated. It can be understood that when the function control for translation is activated, the media file is to be translated, and when the function control for translation is deactivated, the translation function for the media file is stopped. The function control may also be configured to generally control various function modules configured to execute the automatic translation function. In some embodiments, when the function control is deactivated, a default value of each function module in the user interface is OFF, and when the function control is activated, a set value of each function module in the user interface may be the default value or a value set last time. When the automatic translation function is activated, a state of each function module is an activated state by default.

The automatic translation function may be executed on the media file as follows: firstly, a translation category may be set; then, a target language into which the media file is to be translated is selected; finally, an output mode of the target language is selected. Therefore, the media file to be translated is output in the target language through the output mode selected by the user.

In some embodiments, when the user sets a translation category of the media file, the translation category may include an audio translation category, a text translation category, and an audio & text translation category. When the translation category is set, an interface for the user to make a selection may be provided, in which translation modes for the user to make a selection may be provided. For example, the translation mode may include that only audio in the media file is required to be translated, only text in the media file is required to be translated, and the audio and the text in the media file are required to be translated simultaneously. In this way, the user may set different translation modes to make the media translated present different output states. The above operation will be described in detail below.

After setting the translation category, the user may select the target language into which the media file is to be translated, i.e., a language into which foreign language information that the user hears or sees is to be translated. The display apparatus 200 may create an alternative language list (i.e., a target language list) allowing multiple selection and supported by the display apparatus according to the needs of the apparatus. The user may select one or more languages from the target language list as the target language(s) for translation. Moreover, the target language may also be screened in combination with one or more of other factors including translation speeds of translating a source language of the media file into all to-be-selected languages, use frequencies of the to-be-selected languages, user preference priorities of the to-be-selected languages, average translation accuracy rates of translating the source language into all the to-be-selected languages, etc., which will be described in detail below.

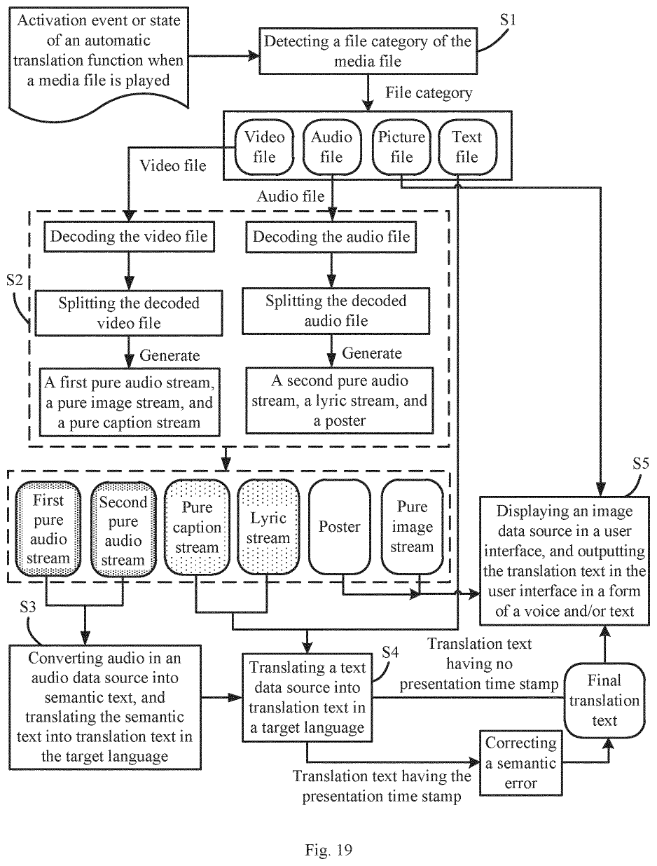

After the target language is determined, the output mode of the target language may be set to display the target language to the user. In some embodiments, the output mode of the target language may include a voice output mode, a text output mode, and a voice & text output mode. The voice output mode is to output the results of translating the media file into the target language only by voice in the target language, that is, to play a final translation result by voice. Since voice playing will occupy an external voice, etc. of the display apparatus, it is required to prompt the user that an original voice of the media file will be replaced by a voice in the target language. The text output mode is to play the results of translating the media file into the target language only in a form of text or words instead of a voice. For the scenario, the user may set a display position of the text or words and determine whether an initial media file has captions, which will be described in detail below. The voice & text output mode is to select the above two output modes simultaneously. After the mode is selected, a voice in the initial media file will be replaced by the voice in the target language, and a content of the text or the words may also be set according to the actual needs, which will be described in detail below. It should be noted that FIG. 18 is a general schematic diagram of an automatic translation flow. Each flow in FIG. 18 will be described in detail in combination with specific embodiments below. In order to facilitate understanding of some embodiments of the disclosure, all steps are described in detail below in conjunction with some specific embodiments and the drawings. FIG. 19 is a schematic flowchart for a display apparatus to process a media file according to some embodiments of the disclosure. As shown in FIG. 19, the display apparatus 200 may process the media file in S1-S5 as follows.

S1: detecting a file category of the media file.

In order to detect an activation state or a deactivation state of the automatic translation function of the media file, when the media file is opened, an activation event or a corresponding state of the automatic translation function may be detected. Then, based on that the automatic translation function is activated when the media file is played, the display apparatus 200 may transmit a broadcast notification to an application playing the media file when preparing to execute automatic translation. For example, the broadcast notification is transmitted to the application playing the media file to prompt the application to prepare to activate the automatic translation function. When the automatic translation function is activated, the display apparatus 200 may start detecting the file category of the media file, so as to execute different translation flows according to different file categories.

In some embodiments, the file category can include a video file, an audio file, a picture file, and a text file. It should be noted that in order to realize a more rapid translation speed and a more accurate translation effect, the display apparatus 200 may be connected to the network, so as to obtain more network resources in the translation process. Accordingly, the translation speed is improved, and the translation accuracy rate is increased. After S1 is completed, S2 may be executed as follows.

S2: based on that the file category is detected as the video file, decoding the video file, and splitting the decoded video file, to generate a first pure audio stream, a pure image stream and a pure caption stream in the media file; based on that the file category is detected as the audio file, decoding the audio file, and splitting the decoded audio file, to generate a second pure audio stream, a lyric stream and a poster in the audio file.

In order to play the video file on the display apparatus, in some embodiments, the display apparatus 200 may decode the video file and split the decoded video file, to generate the first pure audio stream, the pure image stream and the pure caption stream in the media file after decoding is completed. In this way, the display apparatus 200 may execute different translation flows on the media files in different categories.

In some embodiments, the display apparatus 200 may be configured with a media audio analysis module. When the media file opened by the user is the video file, the media audio analysis module may invoke the video file and execute operations such as decoding, splitting, audio extraction, etc., on the video file, so as to extract a complete first pure audio stream, a complete pure image stream, and a complete pure caption stream from the video file. Similarly, the display apparatus 200 may also decode the audio file and split the decoded audio file, so as to generate the second pure audio stream, the lyric stream, and the poster in the media file after decoding is completed. It should be noted that the pure image stream in the video file is different from the poster in the audio file. In conjunction with FIG. 18, the pure image stream may include images frame by frame, whereas the poster is merely one image.

With reference to FIG. 18, in some embodiments, the pure audio streams may be obtained from the video file and the audio file through decoding and splitting. For convenience of distinction and description, the pure audio stream split from the video file is referred to as the first pure audio stream, and the pure audio stream split from the audio file is referred to as the second pure audio stream. In other words, in some embodiments, the media file is divided into a text data source including a text file, a pure caption stream in the video file, and a lyric stream in the audio file; an audio data source including a pure audio stream in the video file and a pure audio stream in the audio file; and an image data source including a pure image stream in the video file, a poster in the audio file, and a picture file. In this way, different translation flows may be executed for different data sources to improve the translation efficiency of the display apparatus 200.

In order to translate the text data source such as the text file, the pure caption stream, or the lyric stream, the display apparatus 200 may be configured with a text translation module. The text translation module may translate the text data source into translation text in the target language. In some embodiments, when the second pure audio stream in the audio file is translated, since the second pure audio stream and a corresponding lyric stream have presentation time stamps (PTSs), and the presentation time stamps are within the same or similar time ranges, the second pure audio stream and the corresponding lyric stream should be basically synchronized and synonymous. Therefore, after the text translation module executes text translation on the second pure audio stream and the lyric stream individually, a semantic error in translation text of the second pure audio stream may be corrected through the translation text of the lyric stream. Therefore, the translation accuracy rate of the translation text of the pure audio stream is increased. Since the poster is merely one image without a presentation time stamp and requires no error correction flow, the display apparatus 200 may control to directly display the poster. Similarly, since the first pure audio stream in the video file should also be basically synchronized and synonymous with a corresponding caption stream within the same time range, after the text translation module executes text translation on the first pure audio stream and the caption stream individually, a semantic error in translation text of the first pure audio stream may also be corrected through the translation text of the caption stream. Therefore, the translation accuracy rate of the translation text of the pure audio stream is increased.

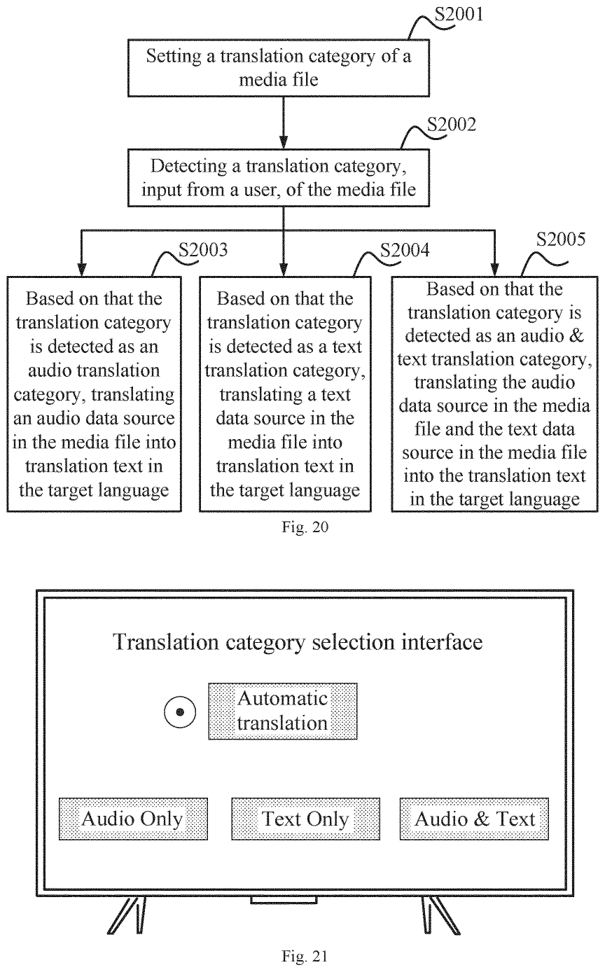

FIG. 20 is a schematic flowchart for a display apparatus to set a translation category according to some embodiments of the disclosure. As shown in FIG. 20, the flow may include following steps.

S2001: setting a translation category of the media file.

In some embodiments, the translation category may include an audio translation category, a text translation category, and an audio & text translation category. After the translation category is set, the display apparatus 200 may detect a translation category of the media file input from the user.

S2002: detecting the translation category of the media file input from the user.

S2003: based on that the translation category is detected as the audio translation category, translating the audio data source in the media file into translation text in the target language.

S2004: based on that the translation category is detected as the text translation category, translating the text data source in the media file into translation text in the target language.

S2005: based on that the translation category is detected as the audio & text translation category, translating the audio data source in the media file and the text data source in the media file into the translation text in the target language.

In some embodiments, FIG. 21 is a schematic diagram of a translation category selection interface according to some embodiments of the disclosure. As shown in FIG. 21, the translation category selection interface may be configured with a translation mode for the user to make selection, for example, Audio Only, Text Only, and Audio & Text. The “Audio Only” indicates that only the audio in the media file is translated, and the display apparatus 200 may translate the audio data source in the media file into the translation text in the target language. The “Text Only” indicates that only the text in the media file is translated, and the display apparatus 200 may translate the text data source in the media file into the translation text in the target language. The “Audio & Text” indicates that the audio and the text in the media file are translated simultaneously, and the display apparatus 200 may translate the audio data source in the media file and the text data source in the media file into the translation text in the target language.

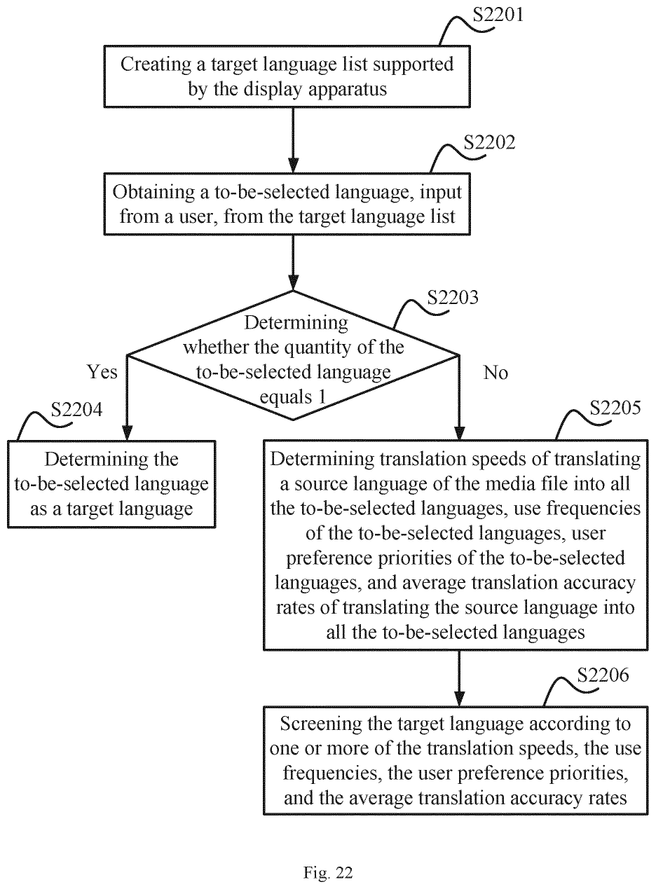

In order to determine the target language into which the media file is to be translated, the display apparatus 200 may further execute a flow as follows. FIG. 22 is a schematic flowchart for a display apparatus to set a target language according to some embodiments of the disclosure. As shown in FIG. 22, the flow can include following steps.

S2201: creating an alternative language list supported by the display apparatus.

S2202: obtaining a to-be-selected language input from the user from the alternative language list.

S2203: Determining whether the quantity of the to-be-selected language equals 1.

The display apparatus 200 may create the alternative language list supported by the display apparatus 200 firstly, then obtain the to-be-selected language input from the user from the alternative language list, and determine the quantity of the to-be-selected language.

S2204: based on that the quantity of the to-be-selected language equals 1, determining the to-be-selected language as the target language.

S2205: based on that the quantity of the to-be-selected language is greater than 1, determining translation speeds of translating the source language of the media file into all the to-be-selected languages, use frequencies of the to-be-selected languages, user preference priorities of the to-be-selected languages, and average translation accuracy rates of translating the source language into all the to-be-selected languages.

S2206: screening the target language according to one or more of the translation speeds, the use frequencies, the user preference priorities, and the average translation accuracy rates.

In some embodiments, the display apparatus 200 may be configured with a target language setting module, which is configured for the user to set a default target language, i.e., a language into which the foreign language information that the user hears or sees is to be translated. The display apparatus 200 may create an alternative language list (i.e., a target language list” allowing multiple selections and supported by the display apparatus according to the actual situation of the apparatus. The user may select one or more languages from the target language list as the target languages for translation. It can be understood that the target language selected by the user should be the language that the user has mastered or at least understood. There is no requirement on whether the user can speak or write in the target language. In other words, the target language selected by the user requires the ability of the user to listen and see at will, but does not require the ability to speak and write.

When the target language is determined from the target language list, if the user selects only one to-be-selected language from the alternative language list, the to-be-selected language is the target language, and the media file must be directly translated into the target language set by the user in the translation process. If the user selects more than one to-be-selected languages from the target language list, the translation speeds of translating the source language of the media file into all to-be-selected languages, the use frequencies of the to be selected languages, the user preference priorities of the to-be-selected languages, and the average translation accuracy rates of translating the source language into all the to-be-selected languages are determined, and the target language is screened according to one or more of the translation speeds, the use frequencies, the user preference priorities, and the average translation accuracy rates.

In some embodiments, when the translation speeds of translating the source language into all the to-be-selected languages is determined, the time taken to translate the source language into the target language may be compared, the translation speed may be more rapid if the translation time is shorter, and the translation speed is slower if the translation time is longer. If the user deems that the translation speed is more important, the target language may be determined according to the translation speed.

When the use frequencies of the to-be-selected languages are determined, the greater the number of using the to-be-selected language in a period of time is, the higher the user preference degree for the to-be-selected language, and the more likely the to-be-selected language is reused. The use frequencies the to-be-selected languages may be calculated by setting start times of the numbers of using the to-be-selected languages. In this way, when the user takes the use frequency as a criterion for selecting the target language, the start times may be taken as a selection basis.

When the user preference priorities of the to-be-selected languages are calculated, the user may set the preference priorities of the to-be-selected languages in the display apparatus 200. The preference priorities indicate the preference degrees of the user for different to-be-selected languages. In this way, when the user takes the preference priority as a criterion for selecting the target language, the preference degree may be used as a selection basis.

When the average translation accuracy rates of translating the source language translation into all the to-be-selected languages are determined, the accuracy rate of each translation may be recorded, so as to determine the average translation accuracy rate. In some embodiments, during each translation, a translation accuracy rate of the to-be-selected language during the translation is fed back. After the source language is translated into the to-be-selected language repeatedly, the average translation accuracy rate of the to-be-selected language is obtained. The higher the average translation accuracy rate is, the more likely the to-be-translated language is recommended by a system and accepted by the user. For example, although an order of favorite languages of the user can be as follows: TL1 Chinese, TL2 English, and TL3 Spanish, if the average translation accuracy rates of the display apparatus 200 for TL1, TL2, and TL3 are 80%, 85%, and 95% respectively, Chinese can be preferentially selected as the target language in a case that the user selects the preference priority as the criterion for the target language. However, TL3 Spanish is preferentially selected as the target language in a case that the user selects the average translation accuracy rate as the criterion for the target language. The target language may also be determined through a combination of the plurality of methods above, which will not be specifically limited in the disclosure. After S2 is completed, S3 may be executed as follows.

S3: converting the audio in the audio data source into semantic text, and translating the semantic text into translation text in the target language.

In some embodiments, if the data category of the media file is detected as the first pure audio stream in the video file or the second pure audio stream in the audio file, the display apparatus 200 converts the audio in the audio data source into the semantic text and translates the semantic text into the translation text in the target language.

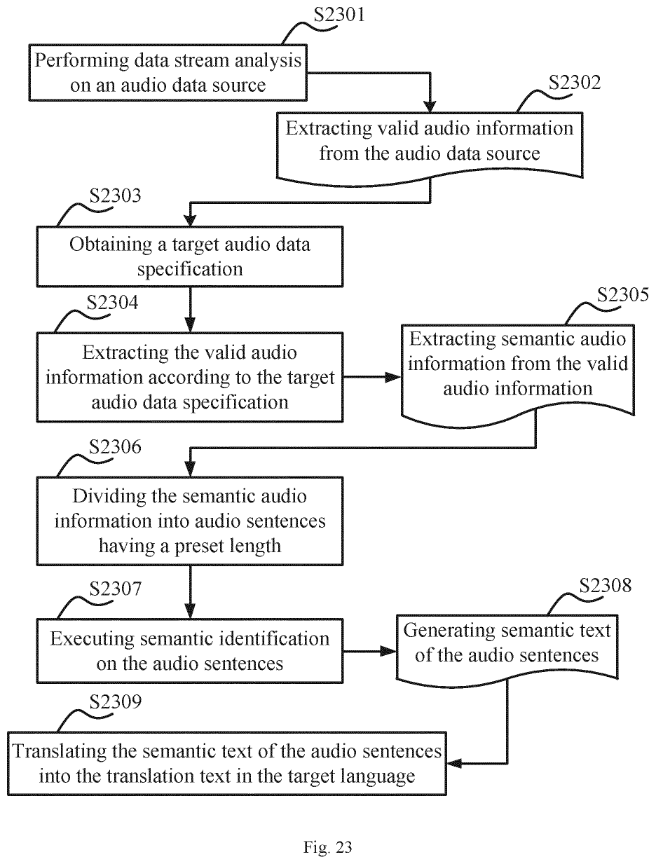

In some embodiments, the audio data source can include a first pure audio stream in the video file, a second pure audio stream in the audio file, and other sound type data. In order to translate the audio data source in the media file into the translation text in the target language, the display apparatus 200 may convert the audio in the audio data source into the semantic text and translate the semantic text into the translation text in the target language. FIG. 23 is a schematic flowchart for a display apparatus to translate an audio data source into translation text a target language according to some embodiments of the disclosure. As shown in FIG. 23, the flow may include following steps.

S2301: performing data stream analysis on the audio data source.

S2302; extracting valid audio information from the audio data source.

S2303: obtaining a target audio data specification.

The display apparatus 200 may execute the data stream analysis on the audio data source firstly, so as to extract the valid audio information from the audio data source, and then obtain the target audio data specification. The specification may specify relevant criteria of audio data and may be formulated in combination with a specific translation content, a specific content of which will not be limited in the disclosure.

S2304: extracting the valid audio information according to the target audio data specification.

S2305: extracting semantic audio information from the valid audio information.

After the target audio data specification is obtained, the display apparatus 200 may extract the valid audio information according to the target audio data specification, so as to extract the semantic audio information from the valid audio information.

S2306: dividing the semantic audio information into audio sentences having a preset length.

S2307: executing semantic identification on the audio sentences.

S2308: generating semantic text of the audio sentences.

S2309: translating the semantic text of the audio sentences into translation text in the target language.

After the semantic audio information is extracted, the semantic audio information may be divided into the audio sentences having the preset length. Then, the semantic identification is executed on the audio sentences, so as to generate the semantic text of the audio sentences. Finally, the semantic text of the audio sentences is translated into the translation text in the target language.

In conjunction with FIG. 18, in some embodiments, in order to improve the accuracy of semantic text translation, a semantic error in the semantic text generated after identification may be corrected, so as to screen out text having a semantic error and improve the accuracy of the semantic text. In this way, when the semantic text is translated into the translation text in the target language, the translation accuracy of the translation text can be improved.

In some embodiments, if the file category of the media file, i.e., a category of to-be-translated data, is the first pure audio stream in the video file or the second pure audio stream in the audio file, the display apparatus 200 may execute data stream analysis on the audio data source, i.e., the first pure audio stream or the second pure audio stream firstly, so as to extract valid audio information from the audio data source. The valid audio information herein may indicate audio information after some noise is removed, so as to facilitate audio extraction and processing flows in a later stage. Then, the target audio data specification specifying the relevant criteria of the audio data may be obtained. It should be noted that the specification may be obtained before or after the data stream analysis, as long as it is obtained before the valid audio information is extracted.

In some embodiments, the specification may include, but is not limited to, relevant requirements on an audio container format, an audio format, a maximum data capacity, a single packet data stream size, a transmission frame rate range, a code rate range, a sampling rate, a compression mode, etc. Moreover, in order to ensure the extraction accuracy of the valid audio information, the specification may be updated regularly or set and updated in a certain step. In some embodiments, the specification may be updated when automatic translation is activated, when the display apparatus 200 is activated or deactivated, or when other steps are performed.

It should be noted that no matter which update form is employed, it is required to ensure that the specification is latest before the valid audio information is extracted. In this way, format analysis and inspection may be executed on the audio data according to the target audio data specification. Different operation flows may be executed according to results of the analysis and inspection.

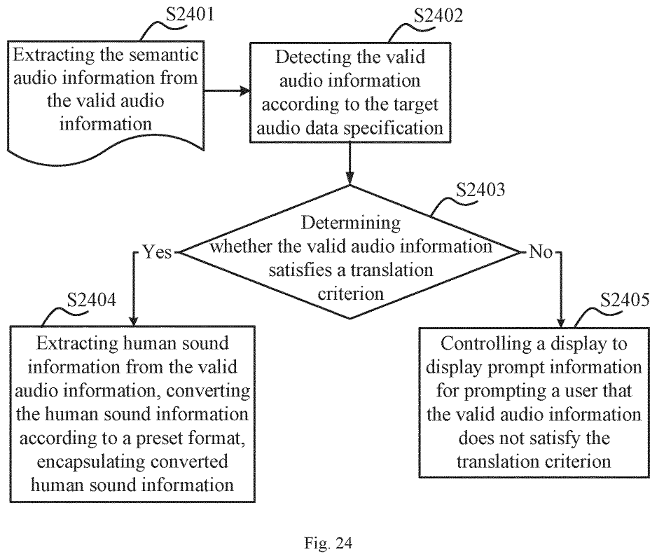

After obtaining the target audio data specification, the display apparatus 200 may extract the valid audio information according to the target audio data specification. FIG. 24 is a schematic flowchart for a display apparatus to extract semantic audio information from the valid audio information according to some embodiments of the disclosure. As shown in FIG. 24, the flow may include following steps.

S2401: extracting the semantic audio information from the valid audio information.

S2402: detecting the valid audio information according to the target audio data specification.

S2403: determining whether the valid audio information satisfies the translation criterion.

S2404: based on that the valid audio information satisfies the translation criterion, extracting human sound information from the valid audio information, converting the human sound information according to a preset format, and encapsulating the converted human sound information.

S2405: based on that the valid audio information does not satisfy the translation criterion, controlling the display to display prompt information for prompting the user that the valid audio information does not satisfy the translation criterion.

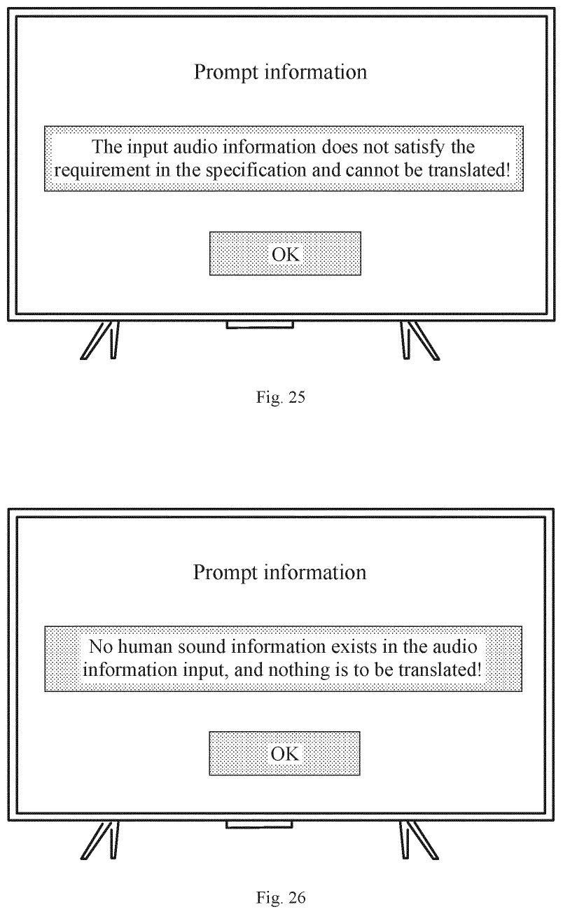

FIG. 25 is a schematic diagram of an effect generated when a display apparatus displays prompt information that no translation criterion is satisfied according to some embodiments of the disclosure. As shown in FIG. 25, after inspection, if the valid audio information is detected as not satisfying the translation criterion, the display apparatus 200 may control the display 260 to display prompt information that “The input audio information does not satisfy the requirement in the specification and cannot be translated” shown in FIG. 25, to prompt the user that the audio information cannot be translated.

In some embodiments, the semantic audio information may be the human sound information. In this way, if the audio information is detected as satisfying the translation criterion, the display apparatus may extract the human sound information from the valid audio information when extracting the semantic audio information from the valid audio information, convert the human sound information according to the preset format, and encapsulate the converted human sound information.

In order to support the display apparatus 200 in executing an audio information extraction function, in some embodiments, the display apparatus 200 may be configured with a media audio preprocessing module, which may be configured to extract the audio information, etc. After the audio information satisfies the target audio data specification, the human sound information may be extracted. In order to support a function of extracting the human sound information, the display apparatus may be further configured with a human sound extraction sub-module. The human sound extraction sub-module is configured to extract human sound from the audio information having various background music and noise, so as to ensure that the human sound that is extracted is as pure as possible. Therefore, the human sound may be accurately identified in a subsequent flow, and a language, a text, etc. corresponding to the source language may be identified.

Since a frequency of the human sound falls within a range, the human sound information may be extracted through several methods as follows in combination with its frequency characteristics and relevant information. In some embodiments, a process of extracting the human sound information may be executed by the human sound extraction sub-module. Several methods for extracting human sound information are described below. It can be understood that the method for extracting human sound information is not limited to the methods below, and the human sound information may also be extracted in other ways, which will not be specifically limited in the disclosure.

In some embodiments, when the human sound information is extracted, firstly, whether the human sound and other background sounds or music in the corresponding audio information are placed in different sound tracks may be detected. If the human sound is positioned in a separate sound track, a human sound track may be extracted directly from the audio information according to a sound track detail. Alternatively, if the sound track detail is unclear, the human sound may be identified according to the human sound frequency range. In this way, other unhuman sound tracks are removed, and the human sound track is maintained, so that a pure human sound audio stream may be obtained.

If human sound is not positioned in a separate sound track, whether there is a reliable method for extracting the human sound may be determined. For example, for audio in which the human sound is positioned in a single channel and evenly distributed to left and right channels, a right channel and a dual channel, and a stereo sound functions as an accompaniment, a dual-channel stereo accompaniment with human sound eliminated may be obtained through subtraction between sound waves of two channels, and then, an accompaniment sound may be subtracted from the sound waves of the left channel and the right channel individually before the human sound is eliminated. Therefore, a purified human sound positioned in the two channels may be obtained. Through the above method, the background music or accompaniment may be eliminated, and the pure human sound information may be finally obtained.

Compared with the above simple cases that the human sound is positioned in the separate sound track and that no human sound is positioned in the separate sound track, in more cases, human sounds in audio are directly mixed with other sounds. In some embodiments, an audio range may be limited to a human sound range through a high-pass filter and a low-pass filter. Then, filtering, noise reduction, sound identification, etc. may be performed through signal processing, pattern identification, etc.

In some other embodiments, the human sound information may also be extracted through an artificial intelligence learning method. In some embodiments, an artificial intelligence method may be configured to learn a human sound at the beginning of an audio segment. After the characteristics such as a timbre, a sound wave frequency band, an amplitude, sound complexity, etc. of the human sound segment are grasped, an audio human sound feature template of the media file is formed. After N human sound feature templates are formed, the N human sound feature templates are stored as a human sound template library of the current media file. Then, when human sound purification is performed on the media file or a subsequent similar media file, matching and searching are performed based on the human sound template library. For example, a human sound template library that has been saved when a previous episode is played may continue being used as the basis when subsequent episodes of the same television series are played. After the human sound template library is established, when the human sound information is extracted, subsequent human sounds may be compared with the human sound template library according to the human sound range, and an audio portion having a feature similarity exceeding a certain threshold may be extracted as a purified human sound of the current audio stream. The threshold may be set in combination with the audio data and the relevant information, a specific value of which will not be limited in the disclosure. After comparison, if no matched human sound is found from the human sound template library, an intelligent learning module may be activated for the human sound in the current audio to learn a human sound template of the audio segment, and a learned human sound template is added to the human sound template library, accumulated previously, of the media file. In this way, a human sound extracted according to a new human sound template may be used as human sound information extracted from a current audio information segment.

In some embodiments, if no human sound information is found from an entire media file, the media file may be determined as pure music, pure noise, a pure animal sound, etc. When extracting human sound information for this media file, the display apparatus 200 outputs an result of the human sound information as null. In this case, the display 260 may be controlled to display prompt information for prompting the user that no human sound exists. FIG. 26 is a schematic diagram of a prompt effect generated when a display apparatus displays that no human sound information exists according to some embodiments of the disclosure. As shown in FIG. 26, when no human sound information exists in audio information input, prompt information “No human sound information exists in input audio information, and nothing is to be translated” shown in FIG. 26 may be displayed. Therefore, the user is prompted that the audio information having no human sound translation is not required to be translated.

After the semantic audio information is extracted through the above method, for example, after the human sound information is extracted, the human sound information may be converted according to the preset format, and the converted human sound information may be encapsulated. In some embodiments, the display apparatus 200 may be configured with a media format conversion sub-module. The media format conversion sub-module primarily executes data stream analysis on the input audio information, extracts useful data, executes data collection and format conversion according to a preset format required in the target audio data specification, such as a target audio format, and finally converts the audio stream into the target audio format, so that semantic extraction may be executed in a subsequent flow. A process of format conversion is actually to fill a corresponding new data structure with corresponding information in the source audio according to information required by the target audio format, and encapsulate the filled data structure according to a container of the target audio format.

In order to translate the semantic audio information extracted into a text form, in some embodiments, the display apparatus 200 may further divide the semantic audio information into the audio sentences having the preset length. The audio stream in the entire media file will be dynamically divided into segments having different lengths, so as to generate several audio sentences. The time of all audio sentences are connected end to end, so as to form an original audio stream in the entire media file. Since the semantic audio information will eventually be translated into the translation text in the target language, the division accuracy of the semantic audio information will affect the accuracy of a translation effect.

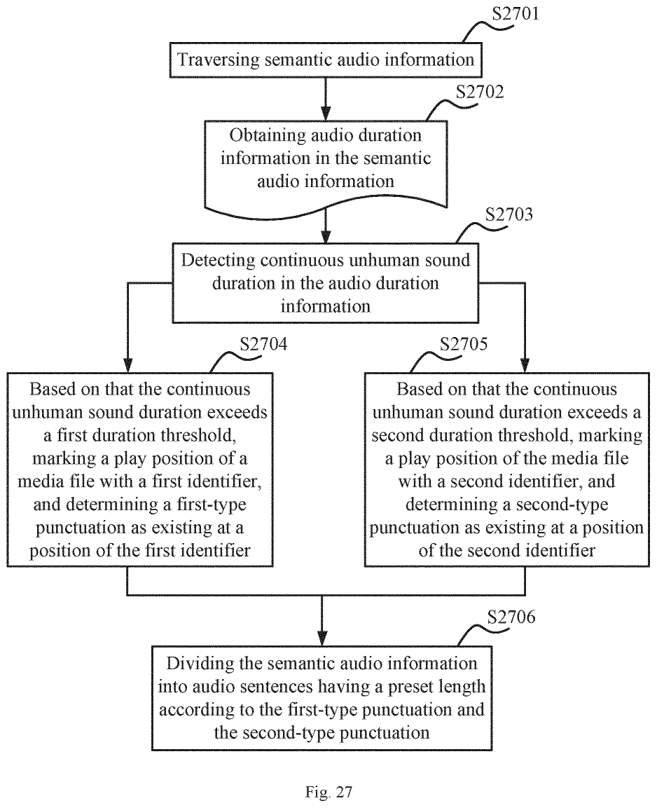

FIG. 27 is a schematic flowchart for a display apparatus to divide semantic audio information into audio sentences having a preset length according to some embodiments of the disclosure. As shown in FIG. 27, the flow may include following steps.

S2701: traversing the semantic audio information.

S2702: obtaining audio duration information in the semantic audio information.

S2703: detecting continuous unhuman sound duration in the audio duration information.

S2704: based on that the continuous unhuman sound duration exceeds a first duration threshold, marking a play position of the media file with a first identifier, and determining that a first-type punctuation exists at a position of the first identifier.

S2705, based on that the continuous unhuman sound duration exceeds a second duration threshold, marking a play position of the media file with a second identifier, and determining that a second-type punctuation exists at a position of the second identifier.

S2706: dividing the semantic audio information into the audio sentences having the preset length according to the first-type punctuation and the second-type punctuation.

In the above flow, the display apparatus 200 may traverse the semantic audio information, so as to obtain the audio duration information in the semantic audio information; detect the continuous unhuman sound duration in the audio duration information; mark the play position of the media file with the first identifier based on that the continuous unhuman sound duration exceeds the first duration threshold, and determine that the first-type punctuation exists at the position of the first identifier; mark the play position of the media file with the second identifier based on that the continuous unhuman sound duration exceeds the second duration threshold, and determine that the second-type punctuation exists at the position of the second identifier, where the second duration threshold is greater than the first duration threshold; and divide the semantic audio information into the audio sentences having the preset length according to the first-type punctuation and the second-type punctuation.

In some embodiments, the division of the audio sentence is more than finding a truncation point of the audio information, but also to find a sentence segmentation position of the audio sentence suitable for translation, for example, a position of the punctuation. The duration for the division of the audio sentence and a sentence capacity are not specifically limited in the disclosure and may be specifically set according to characteristics of the audio information as demanded. Some embodiments of a method for audio sentence division will be described below.

In some embodiments, for a media file having captions, duration for displaying captions on one screen may be taken into consideration. The start and end time of the captions in current semantic audio information may be configured as the start and end time of a corresponding audio sentence. In this way, semantic audio information within the duration for displaying the captions on one screen may be generated into an audio sentence and then converted into an audio sentence in the target audio format. For another example, pauses and moods in the semantic audio information may also be determined, and a segmentation position of the audio sentence may be determined according to a customary “sentence segmentation” way used when the user speaks. In this way, it is required to determine whether a human sound, the continuous unhuman sound duration, etc. exist in the current semantic audio information, and then the division of the audio sentence is executed according to the continuous unhuman sound duration.

In some embodiments, after the semantic audio information is traversed to obtain the audio duration information in the semantic audio information, if the continuous unhuman sound duration in the audio duration information extracted exceeds the first duration threshold, for example, 1 second, a pause may be determined as existing in the semantic audio information, and there should be a comma here. If the continuous unhuman sound duration exceeds the second duration threshold, for example, 3 seconds, it may be deemed that a sentence in the semantic audio information has been finished, and there should be a period here. Moreover, the position may be marked as a truncation point of an audio sentence. Finally, the semantic audio information can be divided into the audio sentences having the preset length according to the comma or period.

In some embodiments, a sentence length of the audio sentence may also be set as demanded in practice. In some embodiments, one sentence may be divided into one audio sentence, or two or more sentences may be divided into one audio sentence, which will not be limited in the disclosure. After the division of the audio sentence is completed, the audio sentence may be configured for subsequent translation. Since forced truncation will cause incomplete audio sentences after division, so as to affect the accuracy of the translation text, the division of the audio sentence may be performed in comprehensive consideration of the performance of the display apparatus, the category of the media file, a category of the source language, a category of the target language, etc. Accordingly, the accuracy rate of the audio sentence division is improved, and the problems of the low translation accuracy rate of the media file and the time and effort for the user to search for a video having understandable captions are avoided.

After the division of the audio sentence of the human sound is completed, the display apparatus 200 may execute semantic identification on the audio sentences, so as to generate semantic text of the audio sentences. In some embodiments, in order for the display apparatus 200 to execute a function of converting the audio sentence into the semantic text, the display apparatus 200 may be configured with an audio semantic identification module. An input object of the audio semantic identification module is the audio sentence obtained in the foregoing embodiment. The audio semantic identification module may perform semantic identification on the audio sentence. In other words, sound information in a voice may be identified from the audio sentence and converted into semantic text in the target language.

It should be noted that before the audio semantic identification module identifies the sound information, a large amount of semantic sound collection, signal processing, mode identification, artificial intelligence training and other operations are required to be executed on the audio semantic identification module. In some embodiments, possible sound features of sounds in various languages may be sampled and analyzed in advance according to requirements in the target audio data specification, and sound feature data and collections of various languages may be formed. Features such as the timbre, the volume, and the frequency and amplitude of sound may also be analyzed, and the collections of the sounds in various languages are searched according to features of audio to be analyzed, so as to match a language having the greatest similarity. Then, a text corresponding to each sound in the audio to be analyzed is specifically identified. The text having the greatest similarity with the sound in the audio to be analyzed is found. All matching text is found through circular searching and matching, so as to form sentences and paragraphs. Finally, the complete audio-to-text semantic text is formed. In conclusion, a process of converting the audio sentences of the human sound into the semantic text in the target language is completed. Finally, the semantic text of the audio sentences may be translated into the translation text in the target language. In other words, the text-to-text translation process is realized. A specific implementation process may be referred to S4 below. After S3 is completed, S4 may be executed as follows.

S4: translating the text data source into translation text in the target language.

In some embodiments, if the file category of the media file is detected as the text file or the data category is detected as the pure caption stream in the video file or the lyric stream in the audio file, the display apparatus 200 translates these text data sources into the translation text in the target language.

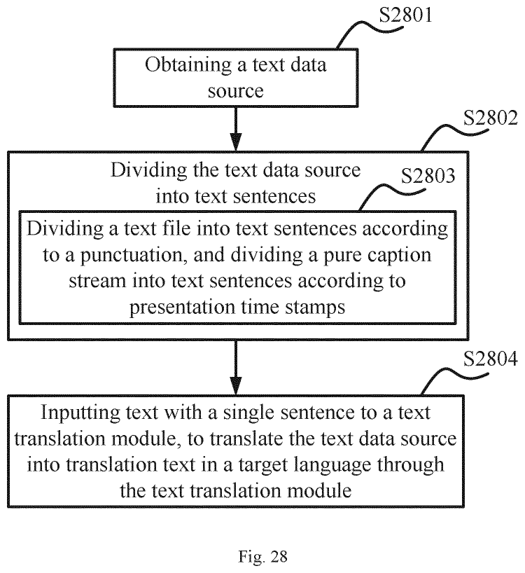

In some embodiments, the text data source can include a text file, a pure caption stream, or a lyric stream, and other pure character-type data. FIG. 28 is a schematic flowchart for a display apparatus to translate a text data source into translation text in a target language according to some embodiments of the disclosure. As shown in FIG. 28, the flow may include following steps.

S2801: obtaining the text data source.

S2802: dividing the text data source into text sentences; the specific division process can be seen in S2803 below.

S2803: dividing the text file into text sentences according to a punctuation, and dividing the pure caption stream into text sentences according to presentation time stamps.

S2804: inputting text with a single sentence to the text translation module to translate the text data source into the translation text in the target language through the text translation module.

In order to support the display apparatus 200 in implementing a function of translating the text data source into the translation text in the target language, in some embodiments, the display apparatus 200 may be configured with a semantic text translation module. The semantic text translation module may be configured to translate the text data source into the translation text in the target language. In some embodiments, all translations may be obtained through the text translation module. A translation process will be described below in conjunction with a specific example.

Before a source language of the media file is translated into the target language, it is required to determine the target language. A method for determining a target language has been described in the foregoing embodiments and will not be repeated herein. The user may set a rule for determining the target language as demanded in practice. After the target language is determined, the display apparatus 200 may obtain the text data source and then divide the text data source into the text sentences. A specific division method may be referred to the method for dividing the audio sentences. In some embodiments, the text file may be divided into the text sentences according to the punctuation, and the pure caption stream may be divided into the text sentences according to the presentation time stamps. A length of the text sentence will not be limited in the disclosure. For example, one sentence may be divided into one text sentence, and two or more sentences may also be divided into one text sentence. After the division of the text sentences is completed, the text sentences are input to the text translation module. The text file, the pure caption stream in the video file, or the lyric stream in the audio file, i.e., the text data source, is translated into the translation text in the target language through the text translation module.

In order to translate the pure caption stream more accurately, the display apparatus 200 may be configured with a semantic translation module. The display apparatus 200 may identify a caption type of the pure caption stream. In some embodiments, the caption type may include a text caption or a picture caption. If the caption category is identified as the text caption, the display apparatus 200 may translate the text caption into caption text having a presentation time stamp through the semantic translation module, and then may directly translate the caption text having the presentation time stamp into translation text in the target language through the text translation module. If the caption type is identified as the picture caption, the display apparatus 200 may extract semantic information from the picture caption, so as to obtain caption text having a presentation time stamp and caption text of the video file indirectly, and translate the caption text having the presentation time stamp into translation text in the target language through the text translation module. In this way, the caption text having the presentation time stamp is finally obtained by executing different preprocessing on the pure caption streams in different categories. Accordingly, the translation accuracy of the pure caption stream is improved.

In order to further improve the translation accuracy of the pure caption stream, in conjunction with FIG. 18, in some embodiments, an error in a translation of a pure audio stream may also be corrected through a caption translation of the same video file, and an error in a translation of a pure audio stream may also be corrected through a lyric translation of the same audio file. Therefore, the translation having the error or ambiguity of the pure audio stream after semantic extraction and translation is screened out, so that the translation accuracy of the pure audio stream is improved.

Various specific methods are available for correcting an error. For example, based on the principle that an audio translation and a caption translation of the same video should be basically the same, and an audio translation and a lyric translation of a song should be basically the same, if a video file has audio and captions, an error in a translation of a pure audio stream is corrected through a translation of a pure caption stream of the video. If an audio file has audio and lyrics, an error in a translation of a pure audio stream is corrected through a lyric translation of the audio file. Error correction may be performed through, but is not limited to, a method as follows: a caption translation having a presentation time stamp (PTS) of the video is compared with a corresponding translation that has been obtained and having a presentation time stamp (PTS) of a pure audio stream of the video: translation text of audio and captions having the same PTS are compared with each other, so as to check whether their semantics and text are similar to each other; an intersection of the same or similar portions is stored as “portions having the same translation”; and different portions between two pieces of translation text may also be stored as “portions having different translations”.

In some embodiments, backtracking error correction can also be performed on different semantic portion. Various specific methods are available for backtracking error correction. For example, in some embodiments, a difference portion between the caption translation and the audio translation in the video file may be taken directly to replace the pure audio stream, i.e., a portion having a big different between the caption translation and the audio translation in the pure audio stream. Therefore, a final translation of the pure audio stream in the video file is formed. In some other embodiments, audio corresponding to different portions of the semantic segment may also be intercepted and transmitted to an audio semantic extraction module for retranslation. A result of re-executing semantic audio identification is input to the audio semantic extraction module, and an input content may be an audio segment corresponding to different semantic portions or audio with one or two words instead of an entire audio sentence before. In this way, the difficulty in local semantic audio identification can be reduced, and the identification accuracy of audio having a suspicious translation portion can be improved. The final translation accuracy of the pure audio stream can be improved by reprocessing, i.e., re-identifying some pure audio streams that may be questionable. Similarly, this method may also be configured to correct the error in the translation of the pure audio stream through the lyric translation of the audio file. Accordingly, the accuracy of the audio translation is improved.

In conjunction with FIG. 18, in some embodiments, for data split from the audio and the video respectively, if the video file has only one or neither of the pure audio stream (i.e., the first pure audio stream) and the caption stream, or the audio file has only one or neither of the pure audio stream (i.e., the second pure audio stream) and the lyric stream, the above error correction process may be skipped. After the text translation module outputs the translation text of the first pure audio stream or the second pure audio stream, the translation of the pure audio stream is directly input to “output translation text according to translation text output settings”.

In some embodiments, before the above text caption and semantic information are translated into the translation text in the target language, the caption text having a presentation time stamp is formed in a process of translating the text caption. The caption text having a presentation time stamp is also generated after the picture semantic information is extracted from the picture caption. Then, the caption text having the presentation time stamp is translated into the translation text through a text translation flow. In order to improve the translation accuracy of the final translation text, semantic error correction may be executed on the translation text generated during text translation. Only a translation text after semantic error correction is the final translation text, so that the accuracy rate of the translation text can be guaranteed.

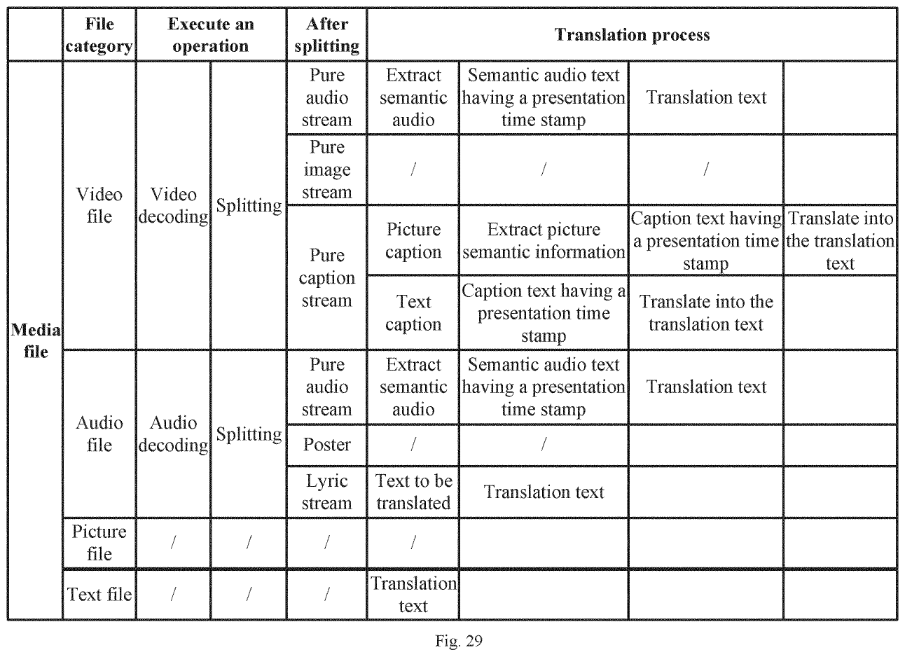

FIG. 29 is a summary chart of a block for a display apparatus to execute a data processing method according to some embodiments of the disclosure. As shown in FIG. 29, as mentioned in the foregoing embodiments, categories of a media file in a source language may be divided into a video file, an audio file, a picture file, and a text file. The display apparatus 200 decodes and splits the video file, so as to form a first pure audio stream, a pure image stream, and a pure caption stream after splitting, and decodes and splits the audio file, so as to form a second pure audio stream, a lyric stream, and a poster after splitting. Then, the media file is divided into three data sources, that is, text data source including a text file, a pure caption stream in the video file, and a lyric stream in the audio file; an audio data source including a first pure audio stream in the video file and a second pure audio stream in the audio file; and an image data source including a pure image stream in the video file, a poster in the audio file, and a picture file. Different translation flows are executed on different data sources.

During specific embodiments, audio in the audio data source is converted into semantic text, and the semantic text is translated into translation text in a target language. The text data source is translated into translation text in the target language. Moreover, a caption category of the pure caption stream may be identified, and different translation flows are executed on pure caption streams in different categories. In conjunction with FIG. 18, in a translation step, the lyric stream having a presentation time stamp, semantic audio text having a presentation time stamp, caption text having a presentation time stamp, and the text file having no presentation time stamp are input to a text translation module. In this way, except for the pure image stream, the poster, and the picture file, the remaining media files have been converted into the translation text in the target language. Therefore, the translation text may be displayed according to the demand set by the user. After S4 is completed, the flow may go to S5 as follows.

S5: displaying the image data source in the user interface, and outputting the translation text in the user interface in a form of a voice and/or text.

During implementation, the display 260 may display the image data source in the user interface. The image data source can include a picture file, a pure image stream, or a poster. The display is further controlled to output the translation text in the form of the voice and/or text in the user interface. In order to output the translation text in the target language to the user interface of the display apparatus 200, after translating the source language of the audio or text, the display apparatus 200 may provide an output mode of the translation text for the user to make a selection. In other words, after the user selects the output mode, the display apparatus 200 may output the translation text in the target language after translation in a corresponding output mode.

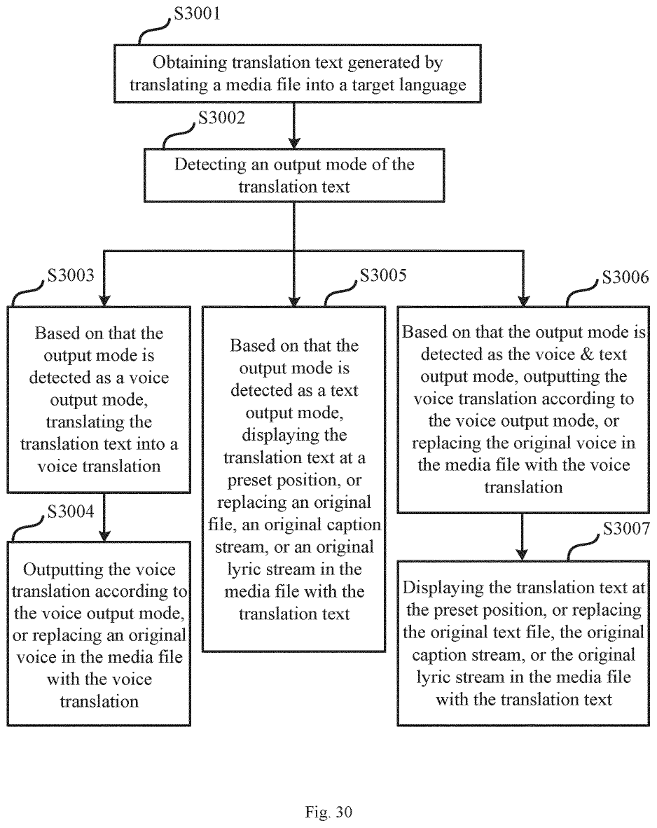

FIG. 30 is a schematic flowchart for a display apparatus to output translation text in a user interface in a form of a voice and/or text according to some embodiments of the disclosure. As shown in FIG. 30, the flow may include.

S3001: obtaining the translation text generated by translating the media file into the target language.

S3002: detecting an output mode of the translation text.

S3003: based on that the output mode is detected as a voice output mode, translating the translation text into a voice translation.

S3004: outputting the voice translation according to the voice output mode, or replacing an original voice in the media file with the voice translation.

S3005: based on that the output mode is detected as a text output mode, displaying the translation text at a preset position, or replacing an original text file, an original caption stream, or an original lyric stream in the media file with the translation text.

S3006: based on that the output mode is detected as the voice & text output mode, outputting the voice translation according to the voice output mode, or replacing the original voice in the media file with the voice translation.

S3007: displaying the translation text at the preset position, or replacing the original text file, the original caption stream, or the original lyric stream in the media file with the translation text.

Through the above flow, the display apparatus 200 can obtain the translation text generated when the media file is translated into the target language when outputting the translation text in the user interface in the form of the voice and/or text, and then detects the output mode of the translation text input from the user. In some embodiments, the output mode of the translation text may include a voice output mode, a text output mode, and a voice & text output mode. If the output mode of the translation text is detected as the voice output mode, the display apparatus 200 may translate the translation text into the voice translation, control the display 260 to output the voice translation according to the voice output mode, or replace the original voice in the media file with the voice translation. If the output mode of the translation text is detected as the text output mode, the display apparatus 200 may control the display 260 to display the translation text at the preset position, or replace the original text file, the original caption stream, or the original lyric stream in the media file with the translation text. If the output mode of the translation text is detected as the voice & text output mode, the display apparatus 200 may control the display 260 to output the voice translation according to the voice output mode, or replace the original voice in the media file with the voice translation, and control the display 260 to display the translation text at the preset position, or replace the original text file, the original caption stream, or the original lyric stream in the media file with the translation text.

In some embodiments, the voice output mode is to output the translation text only in the form of the voice. When the user selects the voice output mode, the display apparatus 200 may convert the translation text into the voice translation. In order to support the display apparatus 200 in implementing the function of translating the translation text into the voice translation, the display apparatus 200 may be configured with a text-to-audio module, which module may convert the translation text in the target language into the voice translation and play the translation text in the form of the voice. In some embodiments, a specific execution process may be as follows: the text-to-audio module may analyze a corresponding code of each letter according to the translation text firstly, for example, may analyze a variable-length letter code corresponding to each letter, and search for pronunciation audio of a corresponding letter or word from a pronunciation audio library inside a media terminal (such as the display apparatus 200) or an external pronunciation audio library according to the variable-length letter code. The pronunciation audio of the letter or word may be preset in the display apparatus 200, which may be referred to as a default built-in pronunciation audio library. The built-in pronunciation audio library may provide languages, in which the translations are played by voice, supported by the display apparatus 200 by default.

In some embodiments, the user may also be supported in downloading pronunciation audio of each letter or word in a designated format from the Internet. The display apparatus 200 may store the pronunciation audio downloaded by the user into the built-in pronunciation audio library. After the storage is completed, it is not required to download the pronunciation audio again for subsequent use, and the pronunciation audio may be directly played as internal pronunciation audio when the voice is played. In addition, the pronunciation audio of each letter or word may also be obtained online in real time. Any method may be employed, as long as a voice translation corresponding to each letter or each word in the translation text may be obtained. Then, the display apparatus 200 may invoke a speaker or earphones to play the corresponding voice translation.

It should be noted that when the user selects the voice output mode, the translation text will not be displayed in the form of words. When the voice translation is played in the form of the voice, it may conflict with the voice in the source language. Therefore, when the original voice exists in the media file in the source language, it is necessary to replace the original voice in the media file with the voice translation. In other words, the original voice in the source language will be replaced by the voice translation in the target language.

The text output mode is to display the translation text in the form of the text only. It can be understood that when the user selects the text output mode for the translation text, the translation text will not be played in the form of the voice. The display apparatus 200 may display the translation text at a designated preset position. Before displaying the translation text, in order to avoid repeated display, whether the original text file or the original caption stream exists when the source language is displayed may be determined. If yes, the display apparatus 200 may replace the original text file or the original caption stream in the media file with the translation text. If no, the display apparatus 200 may display the translation text at the preset position.

In some embodiments, the preset position can be changed. For example, the preset position of the translation text may be dragged. When the translation text is output according to the text output mode, the font, color, transparency, three-dimensional form of the text, an entry effect of the letter and the like may be set. Moreover, in order to improve the display effect of the translation text, before the translation text is output, a content of the translation text including a punctuation, grammar, etc. may be checked. In some embodiments, the display apparatus 200 may be configured with a basic grammar check module. The basic grammar check module may correct a grammar error in the translation text. Moreover, in order to adapt to different languages, the display apparatus 200 may be configured with a plurality of basic grammar check modules. In this way, the translation text is more standardized through one or more basic grammar check modules, and thus the display effect is improved.

The voice & text output mode is to display the translation text in the form of the voice and text simultaneously. If the user selects the voice & text output mode as the output mode of the translation text, when the original voice exists in the media file in the source language, it is necessary to replace the original voice in the media file with the voice translation. When no original voice exists in the media file, the voice translation is directly played. Moreover, whether the original text file or the original caption stream exists when the source language is displayed may be determined. If yes, the display apparatus 200 may replace the original text file or the original caption stream in the media file with the translation text. If no, the display apparatus 200 may display the translation text at the preset position.

Through the above output mode of the translation text, the user can see and/or hear a familiar language. In some embodiments, when the program in the foreign language or another language is played, the display apparatus 200 may automatically translate the foreign language or another language into the target language selected by the user, and output the translation text in the target language in the form of the voice or character. In this way, the user can solve the language barrier when viewing the program in the foreign languages or another language. The media file is automatically translated through the cooperative work of a plurality of modules built in the display apparatus 200. The translation text in the target language is output in an optimal mode selected by the user from a plurality of selectable output modes. In an entire translation process, a voice-to-text translation form is also implemented except for a text-to-text translation form. Accordingly, the problem that when the media file is a foreign language version or another language version that the user cannot directly understand, it cannot be translated. Moreover, the application scenarios of the display apparatus 200 can be enriched, and the application range of the display apparatus can be expanded.

In order to satisfy the translation text output demands of different users, in some embodiments, the display apparatus 200 may further be configured with a translation voice playing special effect module. The translation voice playing special effect module may be configured to perform post-processing on the voice translation in a manner customized by the user. For example, the translation voice playing special effect module may provide a sound effect selection and customization function, so as to add background music or sound effects when the voice translation is played. Accordingly, voice playing demands of different users are satisfied.

In some embodiments, the user may record playing voices for some characters or phrases such as “hello”, when playing this voice translation, internal audio or audio recorded by the user may be employed. When the audio recorded by the user is saved, a new file name may be created for the audio recorded by the user. When the audio recorded by the user is selected to be played, the voice translation corresponding to the translation text will be replaced with the audio of “hello” recorded by the user.

In some embodiments, the user may also add favorite background music when the voice translation is played. For example, a text version of an English poem opened by the user will become a Chinese poem translation after automatic translation. If the user selects the voice output mode to output playing text and sets a specific special effect as the background music for voice playing, a final effect is presented as follows: translation text in a Chinese version having soothing background music is output in the user interface. In this way, the demands of the user in different scenarios can be satisfied.

It should be noted that all the function modules configured in the display apparatus 200, such as the media audio analysis module, the target language setting module, the media audio preprocessing module, the human sound extraction sub-module, the media format conversion sub-module and the like may be set to an deactivated state when no translation function is executed. After the translation function is activated, these modules are activated accordingly. Moreover, when each function module is activated, a default value of each function module may be set. Alternatively, after activation, a value finally set for each function module may be saved, which will not be specifically limited in the disclosure. In this way, the time for the user to set each function module can be shortened while memory resources of the display apparatus 200 can be saved on.

In some embodiments, the automatic translation function may be deactivated after being executed. In conjunction with FIG. 18, when the display apparatus 200 receives a deactivate event or deactivation state of the automatic translation function, all flows and resources related to automatic translation may be stopped and released, so as to exit the automatic translation.

Upon activation event or state of the automatic translation function when the media file is played, the display apparatus 200 according to the above embodiments may detect the file category of the media file, where the file category can include a video file, an audio file, a picture file, and a text file; decode the video file based on that the file category is detected as the video file, and split the decoded video file, to generate the first pure audio stream, the pure image stream, and the pure caption stream in the media file; decode the audio file based on that the file category is detected as the audio file, and split the decoded audio file, to generate the second pure audio stream, the lyric stream, and the poster in the audio file; convert the audio in the audio data source into the semantic text based on that the data category is detected as the first pure audio stream in the video file or the second pure audio stream in the audio file, and translate the semantic text into the translation text in the target language; translate the text data source into the translation text in the target language based on that the file category is detected as the text file or the data category is detected as the pure caption stream in the video file or the lyric stream in the audio file; and control the display to display the image data source in the user interface and output the translation text in the user interface in the form of the voice and/or text. The display apparatus 200 may translate the media file in the foreign language or another language into the translation text in the target language. Accordingly, the problems that when the media file is in the foreign language or another language that the user cannot directly understand, the media file cannot be translated or the translation accuracy rate of the media file is low, and the time and effort are consumed by the user to search for the video having the understandable captions are avoided.

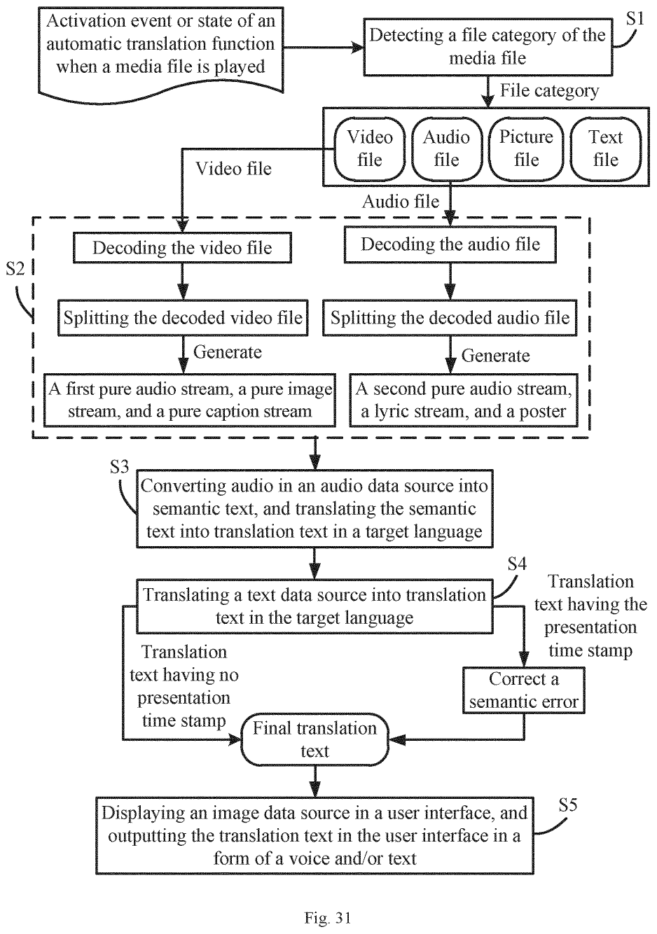

FIG. 31 is a schematic flowchart of a data processing method according to some embodiments of the disclosure. The flow shown in FIG. 31 is described below in conjunction with the foregoing S1-S5.

S1: detecting a file category of a media file.

In some embodiments, the file category can include a video file, an audio file, a picture file, and a text file. It should be noted that in order to realize a more rapid translation speed and a more accurate translation effect, the display apparatus 200 may be connected to the network, so as to obtain more network resources in the translation process, so that the translation speed is improved and the translation accuracy rate is increased. In order to activate the translation function, in some embodiments, the display apparatus 200 may be configured with a function control configured to activate or deactivate the translation function. The function control is configured to control the automatic translation function to be activated or deactivated. It can be understood that when the function control for translation is activated, the media file is to be translated, and when the function control for translation is deactivated, the translation function for the media file is stopped.

S2: based on that the file category is detected as the video file, decoding the video file, and splitting the decoded video file, to generate a first pure audio stream, a pure image stream and a pure caption stream in the media file; and based on that the file category is detected as the audio file, decoding the audio file, and splitting the decoded audio file, to generate a second pure audio stream, a lyric stream, and a poster in the audio file.

In order to play the video file on the display apparatus, in some embodiments, the display apparatus 200 may decode the video file and split the decoded video file, so as to generate the first pure audio stream, the pure image stream, and the pure caption stream in the media file after decoding is completed. In this way, the display apparatus 200 may execute different translation flows on the media files in different categories. Similarly, the display apparatus 200 may also decode the audio file and split the decoded audio file, so as to generate the second pure audio stream, the lyric stream, and the poster in the media file after decoding is completed.

S3: converting audio in an audio data source into semantic text, and translating the semantic text into translation text in the target language.

During implementation, if a data category is detected as the first pure audio stream in the video file or the second pure audio stream in the audio file, the display apparatus 200 converts the audio in the audio data source into the semantic text and translates the semantic text into the translation text in the target language.

In some embodiments, the audio data source can include a first pure audio stream in the video file and a second pure audio stream in the audio file. In order to translate the audio data source in the media file into the translation text in the target language, the display apparatus 200 may convert the audio in the audio data source into the semantic text and translate the semantic text into the translation text in the target language. The display apparatus 200 may execute data stream analysis on the audio data source firstly, so as to extract valid audio information from the audio data source, and then obtain a target audio data specification. The specification may specify relevant criteria of audio data and may be formulated in combination with a specific translation content, a specific content of which will not be limited in the disclosure. After the target audio data specification is obtained, the display apparatus 200 may extract the valid audio information according to the target audio data specification, so as to extract semantic audio information from the valid audio information. After the semantic audio information is extracted, the semantic audio information may be divided into audio sentences having a preset length. Then, the semantic identification is executed on the audio sentences, so as to generate semantic text of the audio sentences. Finally, the semantic text of the audio sentences is translated into the translation text in the target language.

S4: translating a text data source into translation text in the target language.

In some embodiments, if the file category is detected as the text file or the data category is detected as the pure caption stream in the video file or the lyric stream in the audio file, the display apparatus 200 translates the text data source into the translation text in the target language.

In some embodiments, the text data source may include a text file, a pure caption stream, or a lyric stream. In order to support the display apparatus 200 in implementing a function of translating the text data source into the translation text in the target language, in some embodiments, the display apparatus 200 may be configured with a semantic text translation module. The semantic text translation module may be configured to translate the text data source in the media file into the translation text in the target language.

S5: displaying an image data source in a user interface, and outputting the translation text in the user interface in a form of a voice and/or text.

When executing the step that the translation text is output in the user interface in a form of a voice and/or text, the display apparatus 200 may obtain the translation text generated when the media file is translated into the target language, and then detect an output mode of the translation text input from the user. In some embodiments, the output mode of the translation text may include a voice output mode, a text output mode, and a voice & text output mode. If the output mode of the translation text is detected as the voice output mode, the display apparatus 200 may translate the translation text into the voice translation, control the display 260 to output the voice translation according to the voice output mode, or replace the original voice in the media file with the voice translation. If the output mode of the translation text is detected as the text output mode, the display apparatus 200 may control the display 260 to display the translation text at a preset position, or replace the original text file, the original caption stream, or the original lyric stream in the media file by the translation text. If the output mode of the translation text is detected as the voice & text output mode, the display apparatus 200 may control the display 260 to output the voice translation according to the voice output mode, or replace the original voice in the media file with the voice translation, and control the display 260 to display the translation text at the preset position, or replace the original text file, the original caption stream, or the original lyric stream in the media file with the translation text.

In the data processing method according to the above embodiments, the media file in a foreign language or another language that the user cannot directly understand may be translated into the translation text in the target language. Accordingly, the problems that when the media file is in the foreign language or another language that the user cannot directly understand, the media file cannot be translated or a translation accuracy rate of the media file is low, and the time and effort are consumed by the user to search for a video having understandable captions are avoided.

1.-20. (canceled)

21. A display apparatus, comprising:
a display configured to display an image and/or a user interface;
a user input interface configured to receive a command from a user;
a communicating device configured to communicate with an external device according to a predetermined protocol;
a memory configured to store computer instructions and data associated with the display; and
at least one processor in connection with the display, the user input interface, the communicating device, and the memory and configured to execute the computer instructions to cause the display apparatus to:
while a translation function is activated in the display apparatus, collect a first voice input from a first user;
convert the first voice into first text;
determine a language and a first text feature corresponding to the first text by analyzing the first text;
based on that the first text corresponds to a first language, set a second language as a target language, and translate the first text into second text in the second language through the translation function according to the first text feature, wherein the display apparatus is configured to support an instruction in the second language instead of an instruction in the first language;
determine a first instruction corresponding to the second text by parsing the second text; and
in response to the first instruction, execute an operation corresponding to the first instruction;
wherein the memory stores a language translation library and at least one text feature library group;
the language translation library comprises a first mapping between a translated text feature and a text feature translation in the target language, the translated text feature is a text feature in text corresponding to a voice input from the user, and the text feature translation is a translation in the target language corresponding to the translated text feature; and
the at least one text feature library group corresponds to different users individually, each text feature library group comprises at least one text feature library, and each text feature library comprises a text feature in text corresponding to a voice input from a corresponding user;
the at least one processor is configured to execute the computer instructions to cause the display apparatus to determine the language and the first text feature corresponding to the first text by analyzing the first text by:
determining a timbre feature of the first user according to the first voice input from the first user;
according to a second mapping between the timbre feature and the text feature library group, determining a first text feature library group corresponding to the first user from the at least one text feature library group; and
determining a second text feature matched with the first text feature library group and a third text feature unmatched with the first text feature library group from the first text feature; and
the at least one processor is configured to execute the computer instructions to cause the display apparatus to set the second language as the target language and translate the first text into the second text in the second language through the translation function according to the first text feature by:
determining a target translated text feature corresponding to the second text feature from the language translation library, and obtaining a target text feature translation corresponding to the target translated text feature according to the first mapping;
based on that the third text feature exists in the first text feature, translating the third text feature into a fourth text feature in the second language through the translation function; and
generating the second text according to the target text feature translation and the fourth text feature.

22. The display apparatus according to claim 21, wherein the first voice further comprises a first sentence, and the first instruction indicates translation of the first sentence into a first designated language, wherein the at least one processor is configured to execute the computer instructions to cause the display apparatus to execute the operation corresponding to the first instruction by:
in response to the first instruction, determining first subtext corresponding to the first sentence from the first text;
determining a language and a first subtext feature corresponding to the first subtext by analyzing the first subtext;
setting the first designated language as the target language, and translating the first subtext into third text in the first designated language through the translation function according to the first subtext feature; and
displaying the third text.

23. The display apparatus according to claim 22, wherein the at least one processor is configured to execute the computer instructions to cause the display apparatus to determine the language and the first subtext feature corresponding to the first subtext by analyzing the first subtext by:
determining a fifth text feature matched with the at least one text feature library group and a sixth text feature unmatched with the at least one text feature library group from the first subtext feature; and
wherein the at least one processor is configured to execute the computer instructions to cause the display apparatus to set the first designated language as the target language and translate the first subtext into the third text in the first designated language through the translation function according to the first subtext feature by:
determining a target translated text feature corresponding to the fifth text feature from the language translation library, and obtaining a target text feature translation corresponding to the target translated text feature according to the first mapping;
based on that the sixth text feature exists in the first subtext feature, translating the sixth text feature into a seventh text feature in the first designated language through the translation function; and
generating the third text according to the target text feature translation and the seventh text feature.

24. The display apparatus according to claim 23, wherein the at least one processor is further configured to execute the computer instructions to cause the display apparatus to:
store the sixth text feature in the first text feature library group, and store a mapping between the sixth text feature and the seventh text feature in the language translation library.

25. The display apparatus according to claim 21, wherein the at least one processor is further configured to execute the computer instructions to cause the display apparatus to execute the operation corresponding to the first instruction by:
based on that the first voice further comprises a second sentence and a third sentence and the first instruction indicates a translation error generated when the third sentence is taken as a translation of the second sentence, obtaining second subtext corresponding to the second sentence and third subtext corresponding to the third sentence from the first text in response to the first instruction;
determining a language and a second subtext feature corresponding to the second subtext by analyzing the second subtext, and determining a second designated language corresponding to the third subtext by analyzing the third subtext;
setting the second designated language as the target language, and translating the second subtext into fourth text in the second designated language through the translation function according to the second subtext feature;
identifying a translation error in the third subtext by comparing the fourth text with the third subtext, to obtain an identification result; and
displaying the identification result.

26. The display apparatus according to claim 21, wherein the at least one processor is configured to execute the computer instructions to cause the display apparatus to execute the operation corresponding to the first instruction by:
based on that the first voice further comprises a fourth sentence and the first instruction indicates correction of an error in the fourth sentence, obtaining fourth subtext corresponding to the fourth sentence from the first text in response to the first instruction;
determining a third designated language and a third subtext feature corresponding to the fourth subtext by analyzing the fourth subtext;
determining reference text according to the language translation library and the third subtext feature;
identifying a translation error in the fourth subtext by comparing the reference text with the fourth subtext, to obtain an identification result; and
displaying the identification result.

27. The display apparatus according to claim 25, wherein the at least one processor is further configured to execute the computer instructions to cause the display apparatus to:
based on that an error exists in the identification result, obtain the error, and correct the error to obtain fifth text; and
store text having the error, the error, and the fifth text correspondingly.

28. The display apparatus according to claim 21, wherein the at least one processor is configured to execute the computer instructions to cause the display apparatus to execute the operation corresponding to the first instruction by:
based on that the first instruction indicates translation of a first content in first audio and video in a fourth designated language, obtaining sixth text corresponding to the first content in response to the first instruction;
setting the fourth designated language as the target language, and translating the sixth text into seventh text in the fourth designated language through the translation function;
determining a second content according to the seventh text; and
adding the second content to the first content, and/or replacing the first content with the second content.

29. The display apparatus according to claim 21, wherein the at least one processor is configured to execute the computer instructions to cause the display apparatus to execute the operation corresponding to the first instruction by:
based on that the first voice further comprises a fifth sentence and the first instruction indicates translation of the fifth sentence into a fifth designated language and editing of a third content of second audio and video, obtaining fifth subtext corresponding to the fifth sentence from the first text and the third content from the second audio and video in response to the first instruction, wherein the second audio and video comprises an audio portion and/or a text portion, and alternatively, the second audio and video has no text content, and the third content is the audio portion and/or the text portion;
setting the fifth designated language as the target language, and translating the fifth subtext into eighth text in the fifth designated language through the translation function;
determining a fourth content according to the eighth text; and
combining the fourth content with the third content, adding the fourth content to the third content, and/or replacing the third content with the fourth content.

30. A data processing method for a display apparatus comprising:
while a translation function is activated in the display apparatus, collecting a first voice input from a first user;
converting the first voice into first text;
determining a language and a first text feature corresponding to the first text by analyzing the first text;
based on that the first text corresponds to a first language, setting a second language as a target language, and translating the first text into second text in the second language through the translation function according to the first text feature, wherein the display apparatus is configured to support an instruction in the second language instead of an instruction in the first language;
determining a first instruction corresponding to the second text by parsing the second text; and
in response to the first instruction, executing an operation corresponding to the first instruction;
wherein the display apparatus comprises a language translation library and at least one text feature library group;
the language translation library comprises a first mapping between a translated text feature and a text feature translation in the target language, the translated text feature is a text feature in text corresponding to a voice input from the user, and the text feature translation is a translation in the target language corresponding to the translated text feature; and
the at least one text feature library group corresponds to different users individually, each text feature library group comprises at least one text feature library, and each text feature library comprises a text feature in text corresponding to a voice input from a corresponding user;
wherein the determining the language and the first text feature corresponding to the first text by analyzing the first text comprises:
determining a timbre feature of the first user according to the first voice input from the first user;
according to a second mapping between the timbre feature and the text feature library group, determining a first text feature library group corresponding to the first user from the at least one text feature library group; and
determining a second text feature matched with the first text feature library group and a third text feature unmatched with the first text feature library group from the first text feature; and
wherein the setting the second language as the target language and translating the first text into the second text in the second language through the translation function according to the first text feature comprising:
determining a target translated text feature corresponding to the second text feature from the language translation library, and obtaining a target text feature translation corresponding to the target translated text feature according to the first mapping;
based on that the third text feature exists in the first text feature, translating the third text feature into a fourth text feature in the second language through the translation function; and
generating the second text according to the target text feature translation and the fourth text feature.

31. The data processing method according to claim 30, wherein the first voice further comprises a first sentence, and the first instruction indicates translation of the first sentence into a first designated language; the executing the operation corresponding to the first instruction in response to the first instruction comprising:
in response to the first instruction, determining first subtext corresponding to the first sentence from the first text;
determining a language and a first subtext feature corresponding to the first subtext by analyzing the first subtext;
setting the first designated language as the target language and translating the first subtext into third text in the first designated language through the translation function according to the first subtext feature; and
displaying the third text.

32. The data processing method according to claim 31, wherein the determining the language and the first subtext feature corresponding to the first subtext by analyzing the first subtext comprises:
determining a fifth text feature matched with the at least one text feature library group and a sixth text feature unmatched with the at least one text feature library group from the first subtext feature; and
the setting the first designated language as the target language and translating the first subtext into third text in the first designated language through the translation function according to the first subtext feature comprises:
determining a target translated text feature corresponding to the fifth text feature from the language translation library, and obtaining a target text feature translation corresponding to the target translated text feature according to the first mapping;
based on that the sixth text feature exists in the first subtext feature, translating the sixth text feature into a seventh text feature in the first designated language through the translation function; and
generating the third text according to the target text feature translation and the seventh text feature.

33. The data processing method according to claim 32, further comprising:
storing the sixth text feature in the first text feature library group, and storing a mapping between the sixth text feature and the seventh text feature in the language translation library.

34. The data processing method according to claim 30, wherein the executing the operation corresponding to the first instruction in response to the first instruction comprises:
based on that the first voice further comprises a second sentence and a third sentence and the first instruction indicates a translation error generated when the third sentence is taken as a translation of the second sentence, obtaining second subtext corresponding to the second sentence and third subtext corresponding to the third sentence from the first text in response to the first instruction;
determining a language and a second subtext feature corresponding to the second subtext by analyzing the second subtext, and determining a second designated language corresponding to the third subtext by analyzing the third subtext;
setting the second designated language as the target language, and translating the second subtext into fourth text in the second designated language through the translation function according to the second subtext feature;
identifying a translation error in the third subtext by comparing the fourth text with the third subtext, to obtain an identification result; and
displaying the identification result.

35. The data processing method according to claim 30, wherein the executing the operation corresponding to the first instruction in response to the first instruction comprises:
based on that the first voice further comprises a fourth sentence and the first instruction indicates correction of an error in the fourth sentence, obtaining fourth subtext corresponding to the fourth sentence from the first text in response to the first instruction;
determining a third designated language and a third subtext feature corresponding to the fourth subtext by analyzing the fourth subtext;
determining reference text according to the language translation library and the third subtext feature;
identifying a translation error in the fourth subtext by comparing the reference text with the fourth subtext, to obtain an identification result; and
displaying the identification result.

36. The data processing method according to claim 34, further comprises:
based on that an error exists in the identification result, obtaining the error, and correcting the error to obtain fifth text; and
storing text having the error, the error, and the fifth text correspondingly.

37. The data processing method according to claim 30, wherein the executing the operation corresponding to the first instruction in response to the first instruction comprises:
based on that the first instruction indicates translation of a first content in first audio and video in a fourth designated language, obtaining sixth text corresponding to the first content in response to the first instruction;
setting the fourth designated language as the target language, and translating the sixth text into seventh text in the fourth designated language through the translation function;
determining a second content according to the seventh text; and
adding the second content to the first content, and/or replacing the first content with the second content.

38. The data processing method according to claim 30, wherein the executing the operation corresponding to the first instruction in response to the first instruction comprises:
based on that the first voice further comprises a fifth sentence and the first instruction indicates translation of the fifth sentence into a fifth designated language and editing of a third content of second audio and video, obtaining fifth subtext corresponding to the fifth sentence from the first text and the third content from the second audio and video in response to the first instruction, wherein the second audio and video comprises an audio portion and/or a text portion, and alternatively, the second audio and video has no text content, and the third content is the audio portion and/or the text portion;
setting the fifth designated language as the target language, and translating the fifth subtext into eighth text in the fifth designated language through the translation function;
determining a fourth content according to the eighth text; and
combining the fourth content with the third content, adding the fourth content to the third content, and/or replacing the third content with the fourth content.
